(19) United States
(12) Patent Application Publication
(10) Pub. No.: US 2024/0198335 A1
(43) Pub. Date: Jun. 20, 2024

(54) PARTICLE SEPARATION SYSTEMS AND METHODS

(71) Applicant: Swansea University, Swansea (GB)

(72) Inventors: Francesco Del Giudice, Swansea (GB); Keshvad Shahrivar, Guildford (GB)

(73) Assignee: Swansea University, Swansea (GB)

(21) Appl. No.: 18/286,537

(22) PCT Filed: Apr. 8, 2022
(86) PCT No.: PCT/EP2022/059519

§ 371 Date: Oct. 11, 2023

(30) Foreign Application Priority Data
Apr. 12, 2021 (GB) 2105171.9

(51) Int. Cl. B01L 3/00

(52) U.S. Cl. CPC B01L 3/502761; B01L 2200/0647; B01L 2200/0673; B01L 2300/0867; B01L 2300/0883; B01L 2400/0487

(57) ABSTRACT

The invention relates to methods for separating particles in a microfluidic device and, ideally, encapsulating said particles in at least one or a stream of droplets; and a kit of parts for performing said methods.

The present invention relates to methods for separating particles in a microfluidic device and, ideally, encapsulating said particles in at least one or a stream of droplets; and a kit of parts for performing said methods.

### BACKGROUND OF THE INVENTION

The migration of particles and cells transversally to the flow direction due to internal forces generated within the bulk of the flow has been widely exploited in microfluidics for applications ranging from flow focusing to cell separation. Such forces are not generated by external fields such as electric, acoustic or magnetic field, but they are rather induced from within the suspending liquid by either inertial or viscoelastic forces. Inertial forces are relevant at generally large values of the volumetric flow rate while viscoelastic forces are excited by adding a small amount of one or more polymers to the suspending liquid in order to impart elastic properties to the matrix.

Inertial and viscoelastic forces have been extensively employed for microfluidic focusing and separation of particles and cells on different positions along the channel cross-section. For inertial flow, it has been demonstrated that changes in the channel geometry leads to a modification of the equilibrium positions of the flowing particles and cells. For viscoelastic fluids, instead, the flow properties of the suspending liquids have been found to affect the equilibrium position of flowing particles and cells even in simple straight microfluidic channels. The size-dependent nature of both inertial and viscoelastic forces has led to significant advancements in the separation of particles and cells in simple microfluidic geometries.

In addition to the well-studied phenomenon of the size-dependent transversal particle migration, nonlinear forces can be employed to achieve particle or cell ordering, i.e., the formation of strings of spaced particles called ‘particle trains’. The ability to control interparticle spacing is extremely important to optimise encapsulation of particles or cells in droplets, in order to avoid inclusion of multiple objects in the same droplet and/or the formation of empty droplet. Particle trains form at sufficiently large particle or cell concentrations as a consequence of hydrodynamic interactions occurring between consecutive particles. The main bulk of existing literature has so far focused on inertial ordering, meaning that inertial forces are employed to achieve particle ordering and, only very recently has experimental evidence of self-assembly of particle trains in viscoelastic liquids been provided⁸. Specifically, particles suspended in an aqueous hyaluronic acid solution displaying shear-thinning features (i.e., shear viscosity decreases when increasing the flow rate in the microchannel) self-assembled in an almost equally-spaced structure at the centreline of a microfluidic channel. Viscoelastic ordering was also recently observed by Liu et al.²⁰, who designed a microfluidic device for on demand self-assembly of particles. The capability of viscoelastic fluids to promote particle ordering has been also demonstrated through recent numerical simulations²³, where different values of the particle volume fraction led to different particle structures: at very low volume fractions, the particles did not significantly interact and the distribution of the interparticle distances did not change from the initial random one; at intermediate values of the particle concentration, the formation of relatively well spaced particle trains was observed; and at high volume fractions, strings of nearly-touching particles were formed.

Viscoelastic ordering has several advantages over inertial ordering, such as the fact that particles in viscoelastic liquids become spaced on the channel centreline where the shear rate is minimal and the velocity is maximum, at variance with the inertial ordering where particles are either ordered on multiple particle positions, or on a single line near the channel wall where large particle/cell rotation rates may result in blurred images in cytometry applications that employ line-scan based interrogation. Moreover, viscoelastic ordering tends to occur in shear-thinning liquids, meaning that the velocity profile in a microchannel is more flat around the centreline compared to the parabolic one observed in Newtonian liquids. This results in a smaller shear stresses acting on objects flowing around the tube centreline, with obvious advantages when processing delicate cells.

Despite the relevance and the potential impact in a variety of microfluidic applications, works on viscoelastic ordering are very limited, and many open questions still remain. The only two previously mentioned experimental studies^{8,20} considered aqueous solutions of hyaluronic acid as suspending fluids, and it is not clear whether different polymer solutions displaying shear-thinning features are able to drive formation of particle trains on the centreline. In the previous works^{8,20}, hyaluronic acid has only been employed to demonstrate particle train formation in microchannels using a single polymer concentration. Furthermore, the hyaluronic acid solutions employed by Del Giudice et al.⁸ presented a large zero-shear viscosity which can cause problems during particle or cell mixing. Moreover, previous studies, both numerical and experimental, failed to fully characterise or reduce the impact of doublets or triplets of attached particles on the formation of a stable train. A critical step further to the existing studies is the encapsulation of particles in a controlled manner, i.e., above the stochastic encapsulation limit. This step is not straightforward and it does not easily relate to the existing studies^{8,20} for several reasons: i) the flow rate values that can lead to particle ordering may not necessarily be compatible with the formation of droplets in microfluidic configurations; ii) the concentration of polymer in solution needs to be optimised in a way that can lead to droplet formation as well as particle ordering; iii) the encapsulation above the Poisson limit requires the simultaneous optimisation of polymer solution, volumetric flow rate of the fluids containing droplets, volumetric flow rate of the immiscible liquid required to “cut” the droplet, selection of the channel cross-section for the simultaneous ordering and encapsulation and channel length.

Formation of droplet and particle crystals can be seen as the ‘prelude’ to a vast range of applications featuring both types of crystals. On the one hand, microfluidic crystals can be used to enhance the compartmentalisation efficiency of particles and cells in order to defeat the Poisson statistic problem, which is a very important aspect when targeting single-cell analysis. On the other hand, compartmentalisation of either rigid particles or liquid droplets in another larger droplet where they can self-assemble in ordered crystals is appealing for the fabrication of colloidal crystals and photonic materials.

In this work, we demonstrate that a viscoelastic shear-thinning aqueous solutions, in particular aqueous Xanthan Gum or hyaluronic acid solutions, drives the self-assembly of ‘particle trains’ on the centreline of a microchannel that are characterized by a preferential spacing, quantified in terms of distributions of the interparticle distance. The use of xanthan gum as a particle suspending liquid is advantageous over, and so is preferred to e.g. hyaluronic acid, because of its strongly shear-thinning properties at relatively low polymer mass concentrations, resulting in smaller zero-shear viscosity values. Furthermore, by careful selection of channel design, suspending liquid and flow rate, we were able to reduce the occurrence of multi-particle strings, mainly doublets and triplets, that interrupt the continuity of the particle train.

Moreover, such optimized particle trains were combined with an immiscible oil flow to encapsulate separated particles in droplets, minimising the occurrence of encapsulating multiple particles in a single droplet and/or forming empty droplets, and to increase the encapsulation efficiency above the Poisson limit.

In addition, this novel particle encapsulation technique was applied to a system combining a plurality of such optimized particle train streams with an immiscible oil flow to co-encapsulate a plurality of populations of separated particles in oil droplets, minimising the occurrence of encapsulating multiple particles from the same population of separated particles in a single droplet and/or forming empty droplets, and to increase the encapsulation efficiency above the Poisson limit.

### STATEMENTS OF INVENTION

The present invention, in its various aspects, is as set out in the accompanying claims.

According to a first aspect of the invention there is provided a method of separating particles in a microfluidic device, the method comprising:
i) providing a microfluidic device comprising at least one microchannel, the microchannel comprising at least one first inlet and at least one first outlet;
ii) forming a mixture by suspending said particles in an aqueous viscoelastic liquid; and
iii) introducing said mixture into said microchannel via said first inlet and flowing said mixture through said microchannel at a flow rate (Q) of from 0.25 μl/min to 50 μl/min,
characterised in that said microchannel satisfies the formula L/D≥2000, wherein L represents the length of said microchannel and D represents the cross-sectional diameter of said microchannel, and said viscoelastic liquid comprises from 0.15 wt. % to 0.55 wt. % xanthan gum or from 0.05 wt. % to 1.0 wt. % hyaluronic acid.

As used herein, the terms ‘separation’ and/or ‘separating’, when used in the context of particles, refers to the assembly of particle trains characterised by a preferential spacing that can be quantified in terms of an interparticle distance. Such a separation of particles reduces, but does not necessarily eliminate, the occurrence of multiparticle strings/agglomerates that disrupt the continuity of the said particle trains.

In preferred embodiments, the microchannel is curvilinear, and may be a serpentine or spiral microchannel. In particularly preferred embodiments, the curvilinear microchannel has a radius of curvature of from 2.5 mm to 25 mm. 5 In some embodiments, the microchannel has a circular cross section. As used herein, the term ‘circular’ refers to any shape having rounded corners in which the maximum height (diameter) is equal to the maximum width±15%. Alternatively, the microchannel has a square cross section, As used herein the term ‘square’ refers to any shape having four substantially straight edges with substantially 90º corners in which the maximum height (diameter) is equal to the maximum width±25%.

In preferred embodiments, the cross-sectional diameter, i.e. maximum height/width, of the microchannel is a figure between 50 μm and 500 μm, and more preferably a figure between 75 μm and 150 μm. A cross-sectional diameter of 100 μm is particularly suitable. 15 The length of the microchannel is preferably at least 100 mm. Similarly, in preferred embodiments, the microchannel has a length (L) and diameter (D) such that the formula L/D≥2500 is satisfied. Such microchannels provide sufficient length to ensure that both the initial particle focussing into a 1-dimensional line within the channel and subsequent particle separation is completed within the microchannel structure. As the skilled person will appreciate, there is no upper limit to the microchannel length. However, in practice shorter lengths are preferred for reasons of speed and/or economics.

As noted above, the particles to be separated are provided in the form of a mixture by suspending said particles in an aqueous separation liquid comprising xanthan gum. In preferred embodiments, the mixture comprises said particles in an amount from 0.1 wt. % to 1 wt. %. Further, said particles preferably have a diameter (d) of from 10 μm to 50 μm, more preferably from 20 μm to 30 μm.

In one embodiment, the particles to be separated are suspended in an aqueous liquid comprising 0.15 wt. % to 0.55 wt. % xanthan gum. Preferably, such aqueous separation liquid comprises from 0.2 wt. % to 0.4 wt. % xanthan gum. Most preferably, the aqueous separation liquid comprises 0.3 wt. % xanthan gum.

In an alternative embodiment, the particles to be separated are suspended in an aqueous liquid comprising 0.05 wt. % to 1.0 wt. % hyaluronic acid. Preferably, such aqueous separation liquid comprises from 0.1 wt. % to 0.75 wt. % hyaluronic acid. Most preferably, the aqueous separation liquid comprises from 0.25 wt. % to 0.65 wt. % hyaluronic acid. In exemplary embodiments, the aqueous separation liquid comprises from 0.3 wt. % or 0.5 wt. % hyaluronic acid.

Preferably, the microchannel provides a confinement ratio B of from 0.15 to 0.5, calculated using the formula B=d/D wherein d represents the diameter of said particles in said mixture and D represents the cross-sectional diameter of said microchannel. More preferably, the microchannel provides a confinement ratio B of from 0.2 to 0.4. By restricting the confinement ratio in this way, particles are focussed on the centreline of the microchannel in shear-thinning liquids such as used in the present invention.

When the particles to be separated are suspended in an aqueous liquid comprising xanthan gum, the mixture of particles preferably flows through the microfluidic device at a flow rate (Q) of from 0.3 μl/min to 15 μl/min, and more preferably from 0.4 μl/min to 8 μl/min. Such flows rates have been found to provide excellent particle separation (minimizing particle doublet and triplet formation) and also allow for the microchannel flow to be combined with water immiscible encapsulation liquid to prepare encapsulated separated particles. As would be readily appreciated by the skilled artisan, such flow may be induced within the microfluidic device by imposing a pressure drop between the inlet and outlet. In preferred embodiments, the mixture of particles flow through the microfluidic device at a flow rate (Q) which results from the imposition of a pressure drop (ΔP) of from 250 mbar to 3000 mbar, and more preferably from 500 mbar to 1500 mbar.

When the particles to be separated are suspended in an aqueous liquid comprising hyaluronic acid, the mixture of particles preferably flows through the microfluidic device at a flow rate (Q) of from 1 μl/min to 15 μl/min, and more preferably from 1.5 μl/min to 10 μl/min. Such flows rates have been found to provide excellent particle separation (minimizing particle doublet and triplet formation) and also allow for the microchannel flow to be combined with water immiscible encapsulation liquid to prepare encapsulated separated particles. Such flow may be induced within the microfluidic device by imposing a pressure drop between the inlet and outlet. In preferred embodiments, the mixture of particles flow through the microfluidic device at a flow rate (Q) which results from the imposition of a pressure drop (ΔP) of from 500 mbar to 2000 mbar, and more preferably from 1000 mbar to 1750 mbar.

Therefore, according to a second aspect of the invention, there is provided a method of producing droplets containing separated particles, the method comprising:
i) providing a microfluidic device comprising at least one microchannel, the microchannel comprising at least one first inlet, at least one first outlet and at least one second inlet;
ii) forming a mixture by suspending said particles in an aqueous viscoelastic liquid;
iii) introducing said mixture into said microchannel via said first inlet and flowing said mixture through said microchannel at a flow rate (Q) of from 0.25 μl/min to 50 μl/min; and
iv) whilst introducing said mixture into said microchannel via said first inlet, simultaneously introducing a water immiscible encapsulation liquid into the microfluidic device via said second inlet at a flow rate (Q′) of from 0.25 μl/min to 50 l/min
characterised in that said microchannel satisfies the formula L/D≥2000, and said second inlet is positioned downstream of said first inlet at a distance that satisfies the formula L/D≥2000, wherein L represents the length of said microchannel and D represents the cross-sectional diameter of said microchannel, and said viscoelastic liquid comprises from 0.15 to 0.55 wt. % xanthan gum or from 0.05 wt. % to 1.0 wt. % hyaluronic acid.

Preferably, the water immiscible encapsulation liquid is a mineral oil, more preferably a mineral oil having a viscosity of from 15 to 45 mPa·s, measured at standard temperature and pressure using a stress-controlled bulk rheometer (AR2000x, TA Instrument).

In preferred embodiments, the interfacial tension, measured using a force tensiometer (e.g. Sigma 702, biolin Scientific), between the mixture and encapsulation liquid is a figure between 2 mN/m and 4 mN/m to provide a stable interface between the two immiscible components. As is readily appreciated by the skilled person, interfacial tension can be readily reduced by the addition of one or more surfactant compounds. A non-ionic surfactant, e.g., Span-80 is particularly suitable for this purpose.

When the particles are dispersed in an aqueous liquid comprising xanthan gum, the encapsulation liquid is preferably introduced into said microchannel via said second inlet at a flow rate (Q′) of from 0.3 μl/min to 15 μl/min, and more preferably from 0.4 μl/min to 8 μl/min. Flow rates (Q′) of 5 μl/min or more are particularly suitable.

When the particles are dispersed in an aqueous liquid comprising hyaluronic acid, the encapsulation liquid is preferably introduced into said microchannel via said second inlet at a flow rate (Q′) of from 1 μl/min to 15 μl/min, and more preferably from 1.5 μl/min to 10 μl/min. Again, flow rates (Q′) of 5 μl/min or more are particularly suitable.

By controlling flow rates Q and Q′, discrete droplets of xanthan gum or hyaluronic acid encapsulated separated particles form within the water immiscible encapsulation liquid.

Preferred features relating to the microchannel, particles, aqueous liquid and flow rate (Q) are as described above for the first aspect of the invention.

According to a third aspect of the invention, there is provided a method of co-encapsulating a plurality of distinct populations of separated particles within individual droplets, the method comprising:
i) providing a microfluidic device comprising at least a first particle separation microchannel, a second particle separation microchannel and at least a first encapsulant microchannel, wherein the first particle separation microchannel, the second particle separation microchannel and the encapsulant microchannel each comprises at least one inlet and at least one outlet, and at least one of said outlets of said first separation microchannel, at least one of said outlets of said second separation microchannel and at least one of said outlets of said encapsulant microchannel converge together to form a shared exit microchannel;
ii) forming a first mixture comprising a first population of particles by suspending said first population of particles in an aqueous viscoelastic liquid, and forming a second mixture comprising a second population of particles by suspending said second population of particles in an aqueous viscoelastic liquid;
iii) introducing via the inlet said first mixture into said first particle separation microchannel, and introducing via the inlet said second mixture into said second particle separation microchannel;
iv) simultaneously flowing said first mixture through said first microchannel and said second mixture through said second microchannel at a flow rate (Q) of from 0.25 μl/min to 50 μl/min; and
v) whilst introducing said first mixture into said first particle separation microchannel and introducing said second mixture into said second particle separation microchannel, simultaneously introducing a water immiscible encapsulation liquid via the inlet into said encapsulant microchannel, and flowing said encapsulation liquid through said encapsulant microchannel at a flow rate (Q′) of from 0.25 μl/min to 50 μl/min,
characterised in that: said first and said second particle separation microchannels each satisfies the formula L/D≥2000, and said first particle separation microchannel, said second particle separation microchannel and said encapsulant microchannel converge at a position downstream of said first inlet of each of said first and said second particle separation microchannels at a distance that satisfies the formula L/D≥2000, wherein L represents the length of said microchannel and D represents the cross-sectional diameter of said microchannel; and said viscoelastic liquid comprises from 0.15 to 0.55 wt. % xanthan gum or from 0.05 wt. % to 1.0 wt. % hyaluronic acid.

In preferred embodiments, the dimensions of the first and second particle separation microchannels are the same. In addition, preferred features relating to said particle separation microchannels and/or said encapsulant microchannel are as described above in relation to the microchannel of the second aspect of the invention.

In preferred embodiments, the cross-sectional diameter, i.e. maximum height/width, of the exit microchannel is a figure between 50 μm and 150 μm, with a cross-sectional diameter of 120 μm being particularly suitable.

As is the case for the particle separation microchannels, in some embodiments, the exit microchannel has a circular cross section. Alternatively, the exit microchannel has a square cross section.

Further, preferred features relating to the particles, aqueous viscoelastic liquid, water immiscible encapsulation liquid, flow rate (Q) and flow rate (Q′) are as described above for the second aspect of the invention.

According to a fourth aspect of the invention, there is provided a kit of parts for use in the method of the first aspect of the invention, the kit comprising: a microfluidic device comprising at least one microchannel, the microchannel comprising at least one first inlet and at least one first outlet, wherein said microchannel satisfies the formula L/D≥ 2000; an aqueous viscoelastic separation liquid comprising from 0.15 wt. % to 0.55 wt. % xanthan gum or from 0.05 wt. % to 1.0 wt. % hyaluronic acid; and a pressure/flow source configurable to affect the flow of said separation liquid through said microchannel at flow rate (Q) of from 0.25 μl/min to 50 μl/min.

Preferred features relating to the microchannel, aqueous liquid and flow rate (Q) are as described above for the first aspect of the invention.

According to a fifth aspect of the invention, there is provided a kit of parts for use in the method of the second aspect of the invention, the kit comprising: a microfluidic device comprising at least one microchannel, the microchannel comprising at least one first inlet, at least one first outlet and at least one second inlet, wherein said microchannel satisfies the formula L/D≥2000, and said second inlet is positioned downstream of said first inlet at a distance that satisfies the formula L/D≥2000; an aqueous viscoelastic separation liquid comprising from 0.15 wt. % to 0.55 wt. % xanthan gum or from 0.05 wt. % to 1.0 wt. % hyaluronic acid; a water immiscible encapsulation liquid; a first pressure/flow source configurable to affect the flow of said separation liquid through said microchannel at flow rate (Q) of from 0.25 μl/min to 50 μl/min; and a second pressure/flow source configurable to affect the flow of said encapsulation liquid through said microfluidic device at a flow rate (Q′) of from 0.25 μl/min to 50 μl/min.

Preferred features relating to the microchannel, aqueous liquid, encapsulation liquid, flow rate (Q) and flow rate (Q′) are as described above for the second aspect of the invention.

According to a sixth aspect of the invention, there is provided a kit of parts for use in the method of the third aspect of the invention, the kit comprising:
a microfluidic device comprising at least a first particle separation microchannel, a second particle separation microchannel and at least a first encapsulant microchannel, wherein the first particle separation microchannel, the second particle separation microchannel and the encapsulant microchannel each comprises at least one inlet and at least one outlet, and at least one of said outlets of said first separation microchannel, at least one of said outlets of said second separation microchannel and at least one of said outlets of said encapsulant microchannel converge together to form a shared exit microchannel, and wherein said first and said second particle separation microchannels each satisfies the formula L/D≥2000, and said first particle separation microchannel, said second particle separation microchannel and said encapsulant microchannel converge at a position downstream of said first inlet at a distance that satisfies the formula L/D≥2000, wherein L represents the length of said microchannel and D represents the cross-sectional diameter of said microchannel;
one or more aqueous viscoelastic separation liquid(s) comprising from 0.15 wt. % to 0.55 wt. % xanthan gum or from 0.05 w.% to 1.0 wt. % hyaluronic acid;
a water immiscible encapsulation liquid;
at least one viscoelastic pressure/flow source(s), said source(s) configurable to affect the flow of said separation liquid through at least said first particle separation microchannel and said second particle separation microchannel at a flow rate (Q) of from 0.25 μl/min to 50 μl/min; and
a further pressure/flow source configurable to affect the flow of said encapsulation liquid through said encapsulant microchannel at a flow rate (Q′) of from 0.25 μl/min to 50 μl/min.

Preferred features relating to the first and second particle separation microchannels, encapsulant microchannel, particles, aqueous viscoelastic liquid, water immiscible encapsulation liquid, flow rate (Q) and flow rate (Q′) are as described above for the third aspect of the invention.

In the claims which follow and in the preceding description of the invention, except where the context requires otherwise due to express language or necessary implication, the word “comprises”, or variations such as “comprises” or “comprising” is used in an inclusive sense i.e. to specify the presence of the stated features but not to preclude the presence or addition of further features in various embodiments of the invention.

Throughout the description and claims of this specification, the singular encompasses the plural unless the context otherwise requires. In particular, where the indefinite article is used, the specification is to be understood as contemplating plurality as well as singularity, unless the context requires otherwise.

All references, including any patent or patent application, cited in this specification are hereby incorporated by reference. No admission is made that any reference constitutes prior art. Further, no admission is made that any of the prior art constitutes part of the common general knowledge in the art.

Preferred features of each aspect of the invention may be as described in connection with any of the other aspects.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

The invention will now be described in detail by way of example only with reference to the following figures:

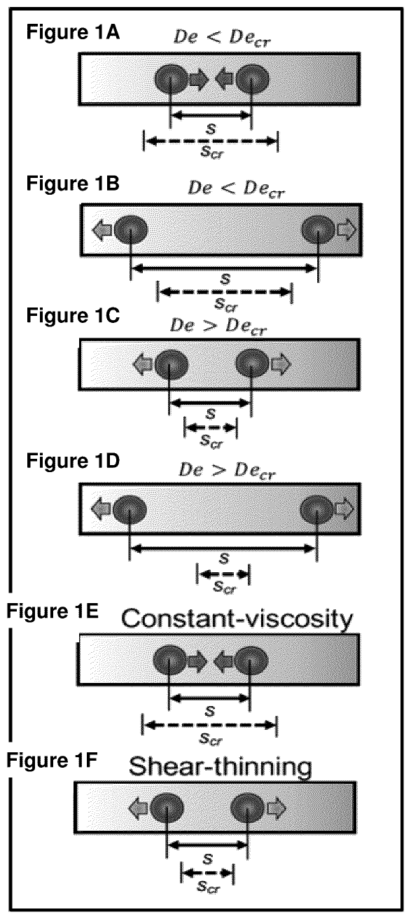

FIG. 1: Schematic representation of attraction and repulsion dynamics between two flowing particles suspended in a viscoelastic liquid, based on the numerical simulations of D'Avino et al.^{23,27}. The value of the critical distance s_{cr} depends upon a number of parameters including the Deborah number De and the fluid rheological properties. a) For a Deborah number lower than a threshold De<De_{cr}, the particles at a distance s <s_{cr} experience an attractive force, thus forming a doublet. b) For De<De_{cr}, adjacent particles at a distance s>s_{cr} experience a repulsive force. c) For De>De_{cr}, the value of the critical distance s_{cr} becomes smaller than (a): particles at the same distance s as in (a) now experience a repulsive force and are pushed further apart. d) For De>De_{cr}, adjacent particles at a distance s>s_{cr} experience a repulsive force. e) Particles suspended in a constant-viscosity liquid (i.e., with negligible shear-thinning) with s<s_{cr} experience an attractive force resulting in the formation of a doublet. f) When the suspending liquid presents shear-thinning features, the value of the critical distance s_{cr} becomes smaller than (e) and particles at the same distance s as in (e) now experiences a repulsive force.

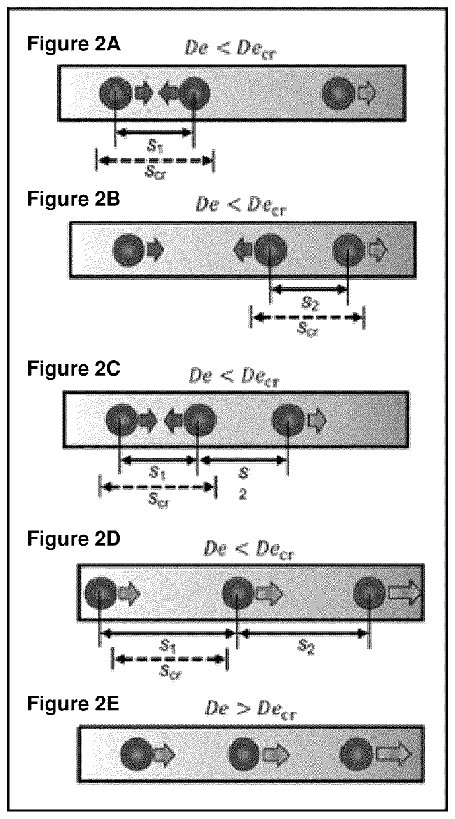

FIG. 2: Schematic representation of attraction and repulsion dynamics between three flowing particles suspended in a viscoelastic liquid, based on the numerical simulations of D'Avino et al.²⁷ The value of the critical distance s_{cr} depends upon a number of parameters including the Deborah number De and the fluid rheological properties. The flow goes from the left to the right. (a)-(c) For a Deborah number lower than a threshold De<De_{cr}, if at least one interparticle distance (s₁ or s₂) is lower than s_{cr}, the trailing and middle particles form a doublet while the trailing one moves away becoming isolated. (d) For De<De_{cr}, if both interparticle distances (s₁ and s₂) are higher than s_{cr}, the three particles separate and become isolated. (e) For De>De_{cr}, the three particles separate regardless of the interparticle distances.

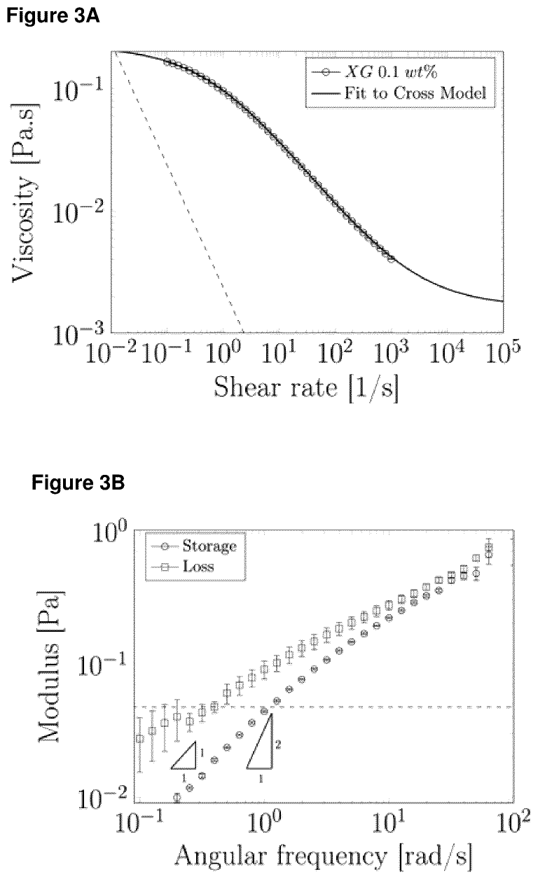

FIG. 3: Rheological properties of Xanthan gum 0.1 wt. % in deionized water. (a) Shear viscosity n as a function of shear rate \dot{γ} in shear rate range 10⁻¹<\dot{γ}<0.3 s⁻¹. Xanthan gum displayed shear thinning behaviour above the critical shear rate γ⁻˜1 s⁻¹. (b) Storage G′ and loss G″ modulus as function of angular frequency ω for an imposed deformation γ=5%. Dashed lines in (a) and (b) shows the minimum value ηₘᵢₙ and Gₘᵢₙ, respectively, detectable by the rheometer due to torque limit: this is represented by ηₘᵢₙ=2Tₘᵢₙ/πR³\dot{γ} (a) and Gₘᵢₙ=2Tₘᵢₙ/(πR³γ) (b), where Tₘᵢₙ=0.1 μN m is the minimum detectable torque, R=30 mm is the radius of the cone, γ is the strain amplitude.

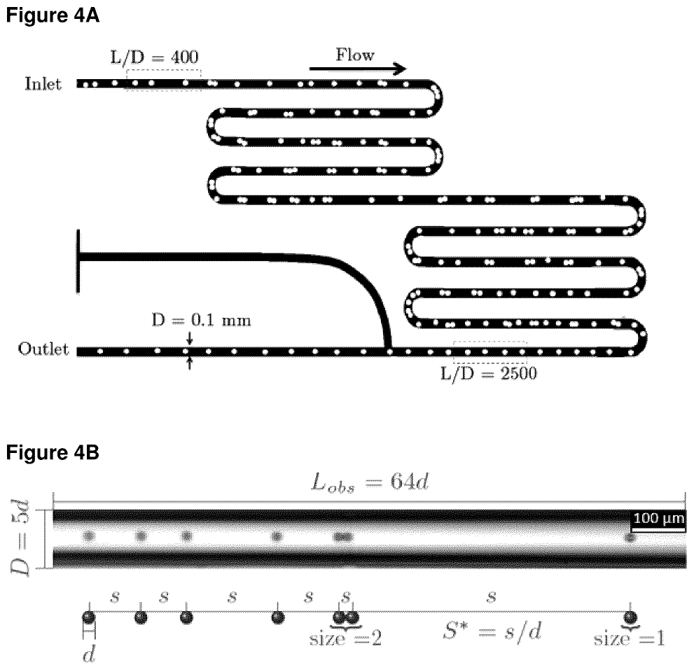

FIG. 4: (a) Schematic representation of the microchannel with relevant dimensions. The internal diameter of the microchannel is D=0.1 mm. Polystyrene particles with diameter d=20±2 μm are observed at a distance from the channel inlet L/D=400 to verify the focusing and at L/D=2500 to analyse the self-assembling and evaluate the interparticle distances. Dimensions are not to scale. (b) The normalised distance between particles S* is determined by comparing the ratio between centre-to-centre distance of adjacent particles s with the particle diameter d, being S*=s/d. Images thresholded to a binary image is used to determine the area of the particles, which in turn is used to determine the particle size. For instance, doublets were represented with a size of 2. Scale bar is 100 μm.

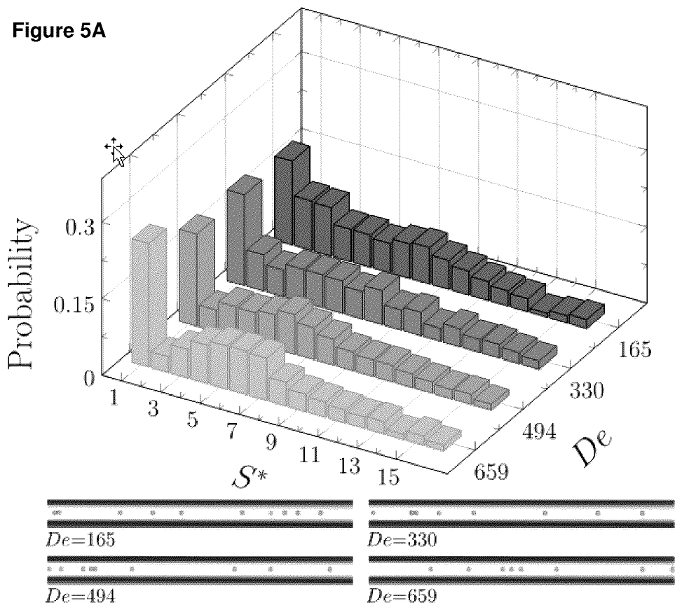

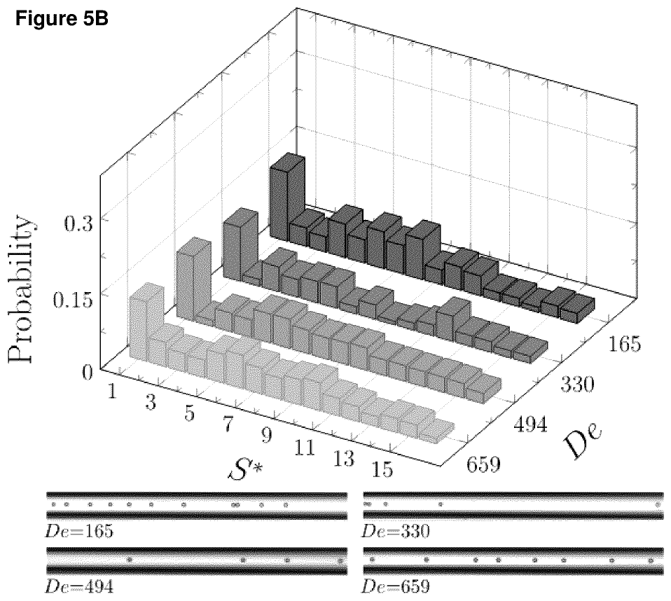

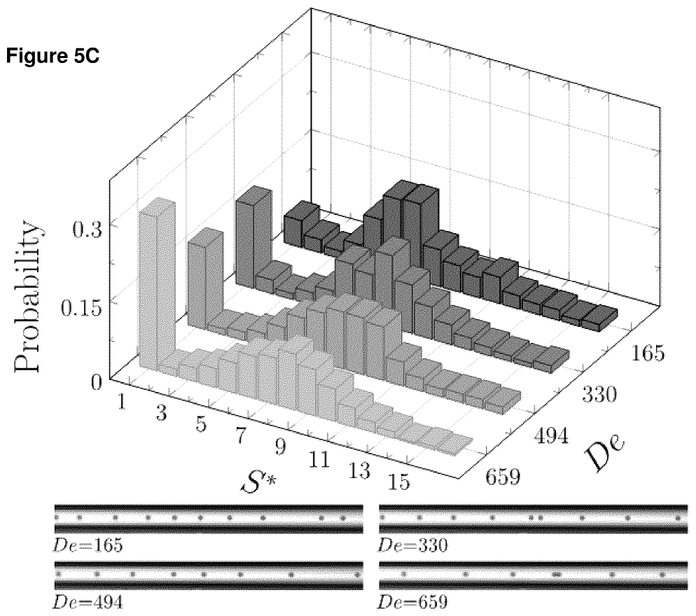

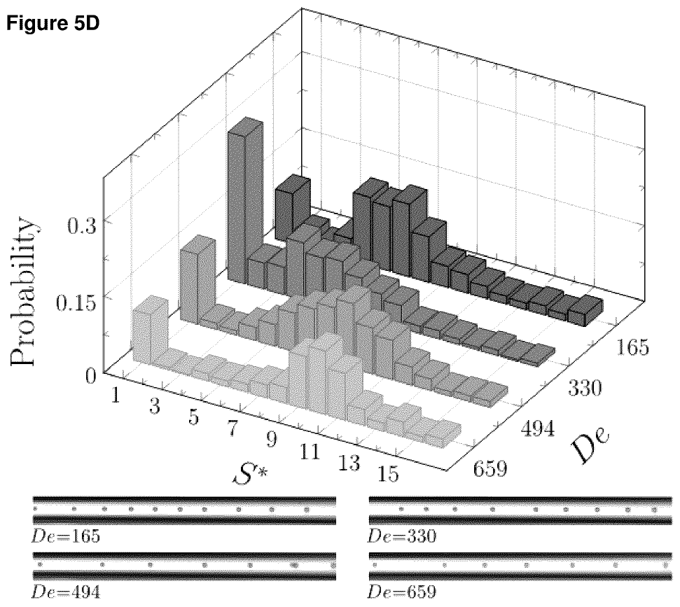

FIG. 5: Histograms of the normalized distance S+=s/d for different Deborah numbers De. Panels (a) and (c) are for LID=400 and LID=2500, respectively, and for a particle bulk concentration of φ=0.2 wt. %. Panels (b) and (d) are for LID=400 and LID=2500, respectively, and for φ=0.3 wt. %. For both q-values, no clear peak is observed in the distributions for LID=400 except the one at S*=1 denoting formation of doublets or triples of touching particles. Particles exhibit some degree of ordering at LID=2500. The interparticle distance depends upon the Deborah number De. Experimental snapshots at different De are shown below each figure with the same colour code as the histograms.

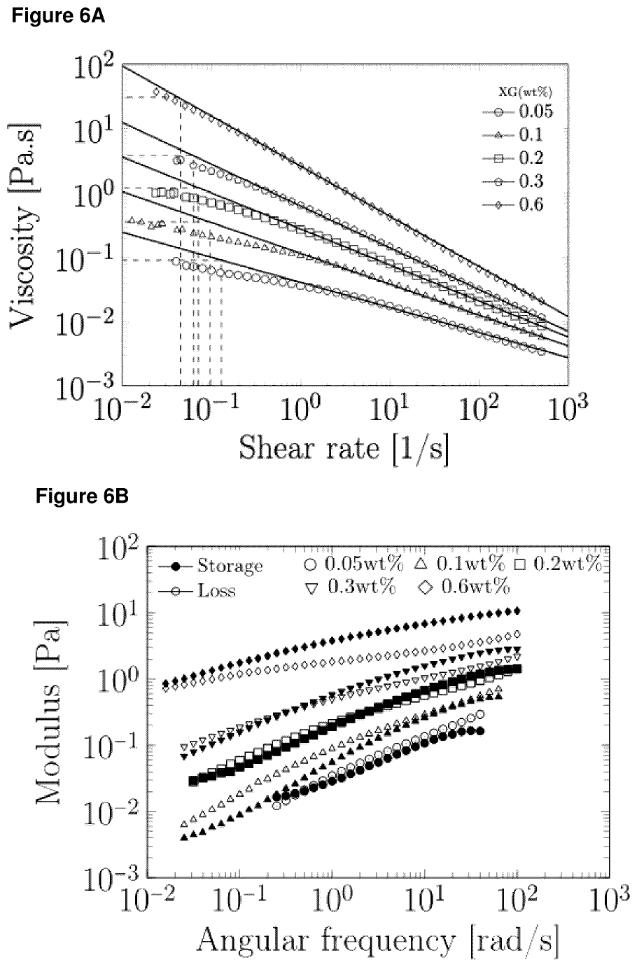

FIG. 6: (a) Shear viscosity of aqueous solution of Xanthan gum as function of shear rate. (b) Storage and los modulus obtained from small amplitude oscillatory shear test.

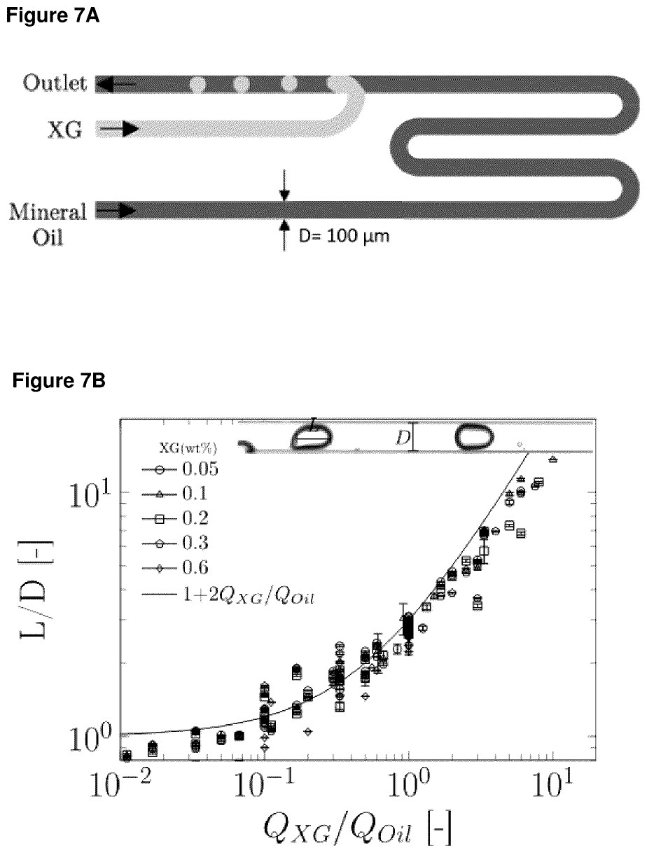

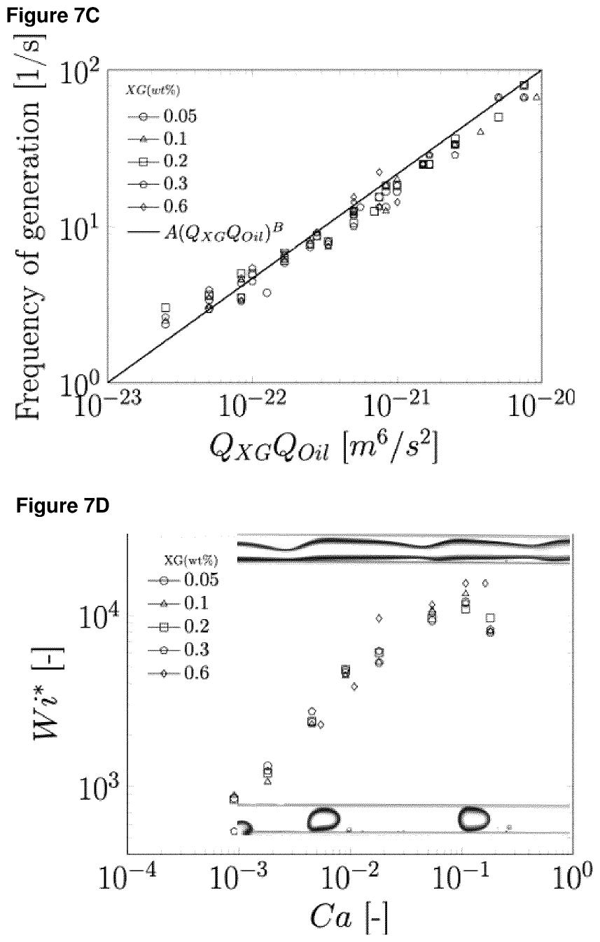

FIG. 7: Xanthan gum droplet generation in a hydrophobic T-junction. (a) Schematic representation of T-junction and fluids inlet. (b) Droplet size show a good agreement with Newtonian prediction. Q_{Oil} and Q_{XG} are the continuous and dispersed flow rate, respectively. (c) Frequency of droplet generation for different concentrations of Xanthan gum. Data points collapse on a master curve of form f=A(Q_{XG}Q_{Oil})B with A=9.22 and B=2/3. (d) Onset of unstable droplet generation. Above the critical dispersed phase flow rate(Q*_{XG}) a transition to parallel flow was observed and droplet formation became unstable. The transition point is proportional to continues phase flow rate and inversely related to Xanthan gum concentration (data not shown). The transition point scales with Weissenberg number for different Xanthan gum concentration. Longest relaxation times were estimated from intersection of power-law region and zero-shear viscosity in FIG. 6a).

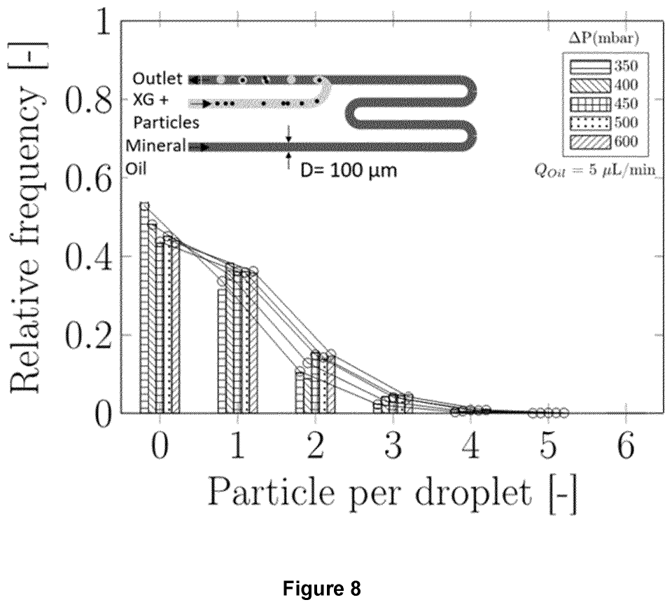

FIG. 8: Relative frequency of particles per droplet for dispersed phase flowing in the short channel. The experimental data is compared with Poisson's statistics which suggest that the short channel length is not enough to establish an ordered structure/particle train before encapsulation at the T-junction.

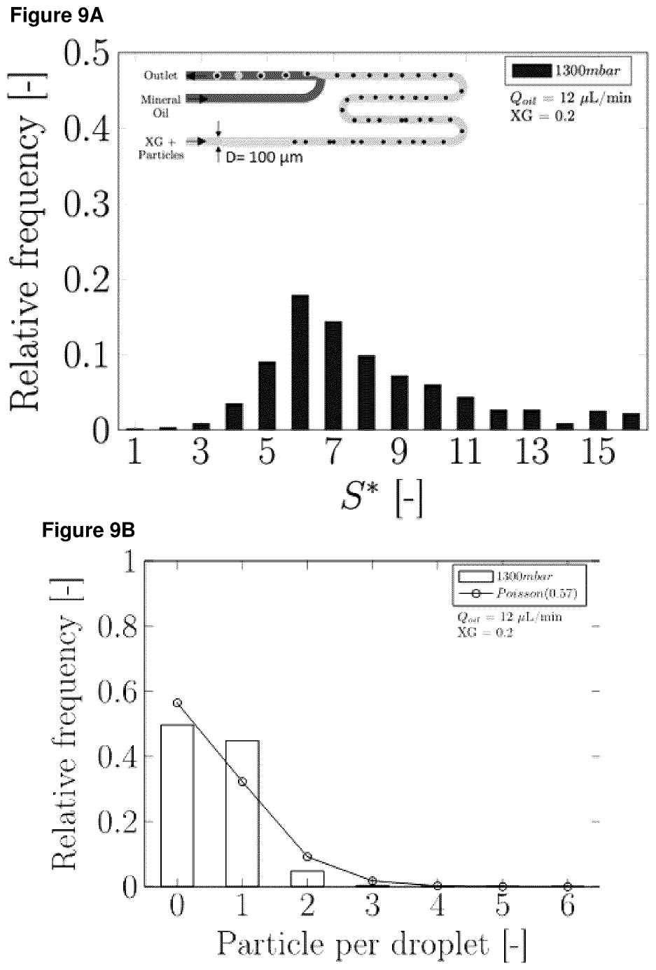

FIG. 9: Ordering and encapsulation in the long channel. (a) Histogram of normalized inter-particle spacing, S*=s/d, before reaching encapsulation area. (b) Histogram of particles per droplet for dispersed phase flowing in the long channel. Experimental data show to outperform the Poisson's statistic, solid line, by achieving an increase in probability of single particle per droplet and a decrease in empty droplets and droplets containing multiple particles.

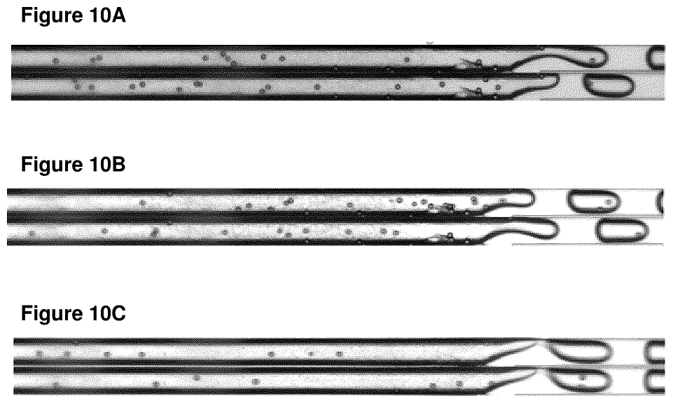

FIG. 10: Ordering and encapsulation of particles using 0.05 wt. % XG at differing pressure drops. (a) 700 mbar (corresponding to an estimated flow rate of approximately 3 μl/min). (b) 900 mbar (corresponding to an estimated flow rate of approximately 4 μl/min). (c) 1300 mbar (corresponding to an estimated flow rate of approximately 5 l/min).

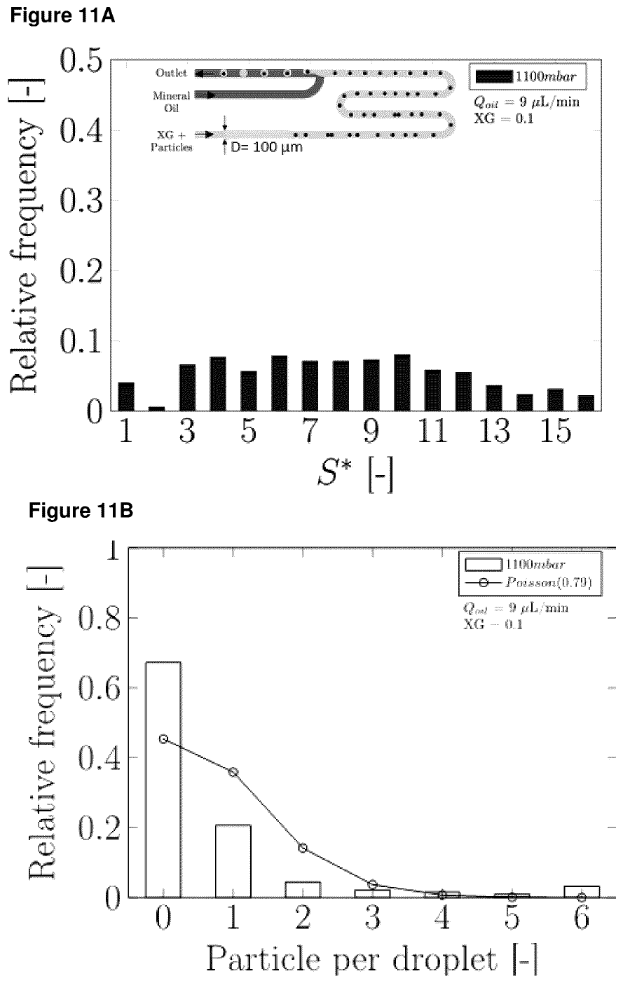

FIG. 11: Ordering and encapsulation in the long channel using 0.1 wt. % XG. (a) Histogram of normalized inter-particle spacing, S*=s/d, before reaching encapsulation area. (b) Histogram of particles per droplet for dispersed phase flowing in the long channel. Experimental data show to underperform the Poisson's statistic, solid line, by achieving a decrease in probability of single particle per droplet and a increase in empty droplets and droplets containing multiple particles.

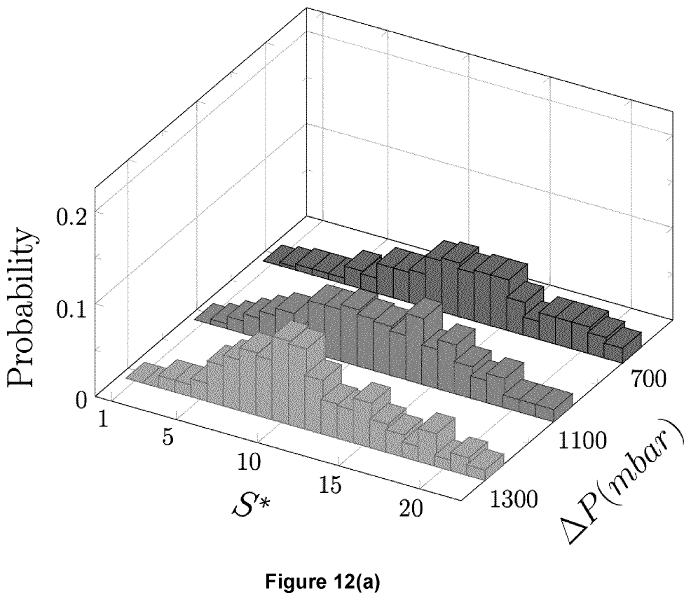

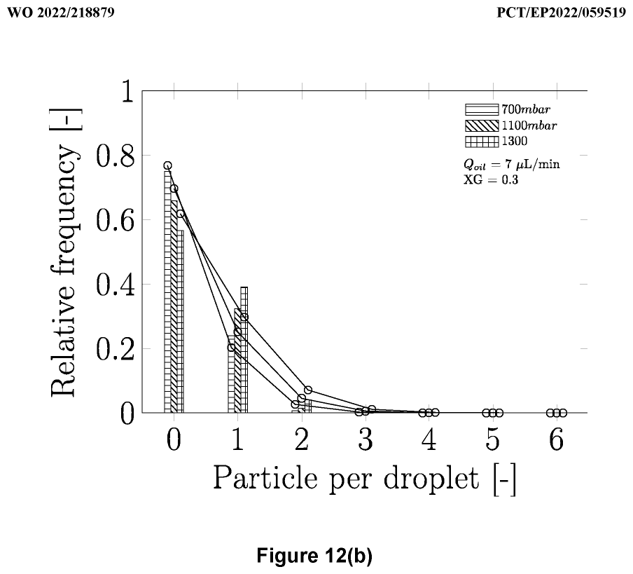

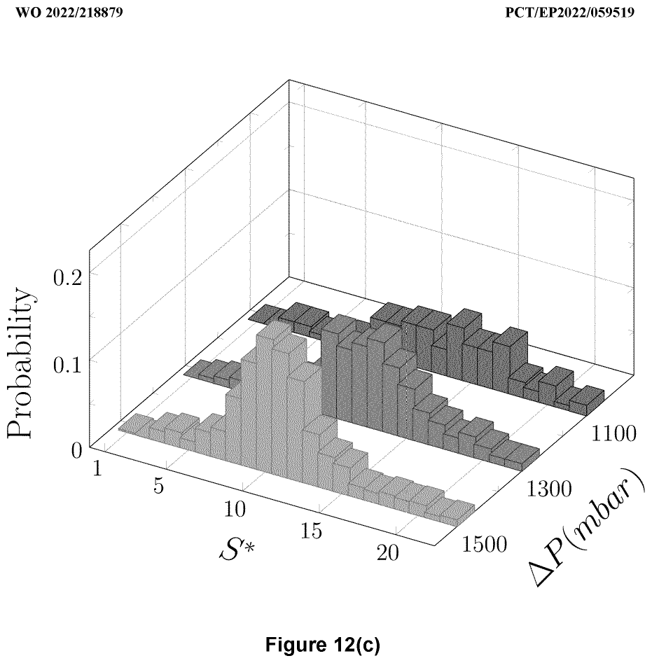

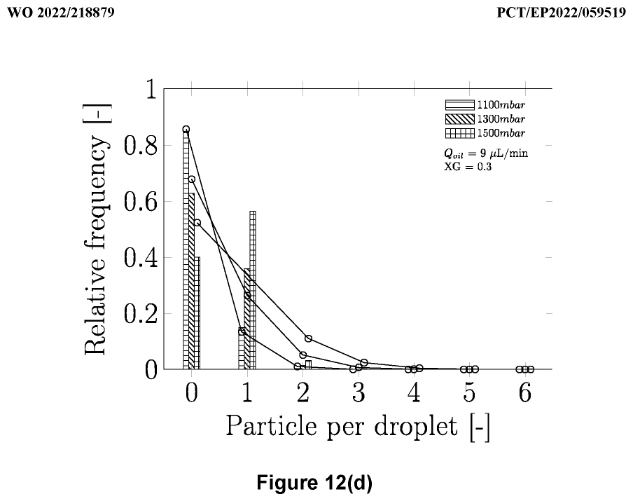

FIG. 12: Ordering and encapsulation in the long channel using 0.3 wt. % XG. (a) Histogram of normalized inter-particle spacing, S*=s/d, before reaching encapsulation area, for different XG flow rates (Q) all tests conducting using an oil flow rate of 7 μl/min. (b) Histogram of particles per droplet for dispersed phase following separation shown in (a). Experimental data shown to outperform the Poisson's statistic (+15%), solid line, by achieving an increase in probability of single particle per droplet and a decrease in empty droplets and droplets containing multiple particles. (c) Histogram of normalized inter-particle spacing, S*=s/d, before reaching encapsulation area, for XG 0.3 wt % and different flow rate/pressure drops all tests conducting using an oil flow rate of 9 μl/min. (d) Histogram of particles per droplet for dispersed phase following separation shown in (c). Experimental data shown to outperform (+25%) the Poisson's statistic, solid line, by achieving an increase in probability of single particle per droplet and a decrease in empty droplets and droplets containing multiple particles.

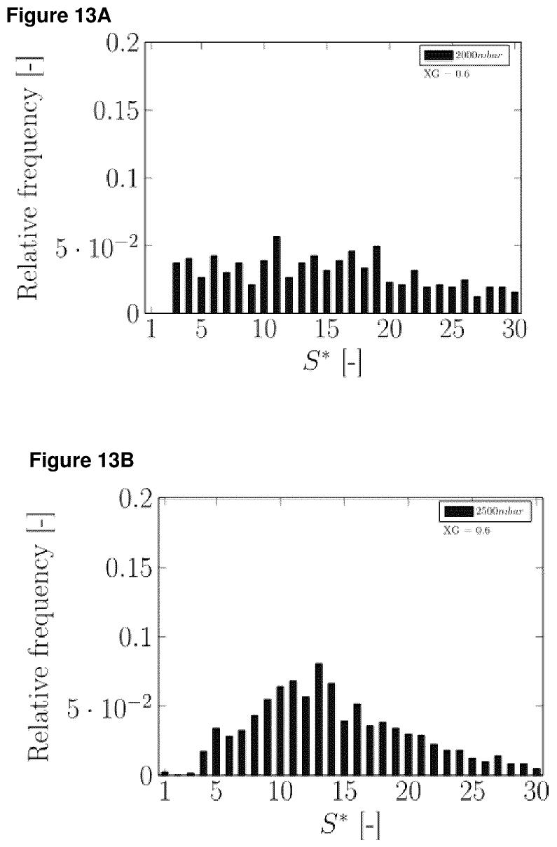

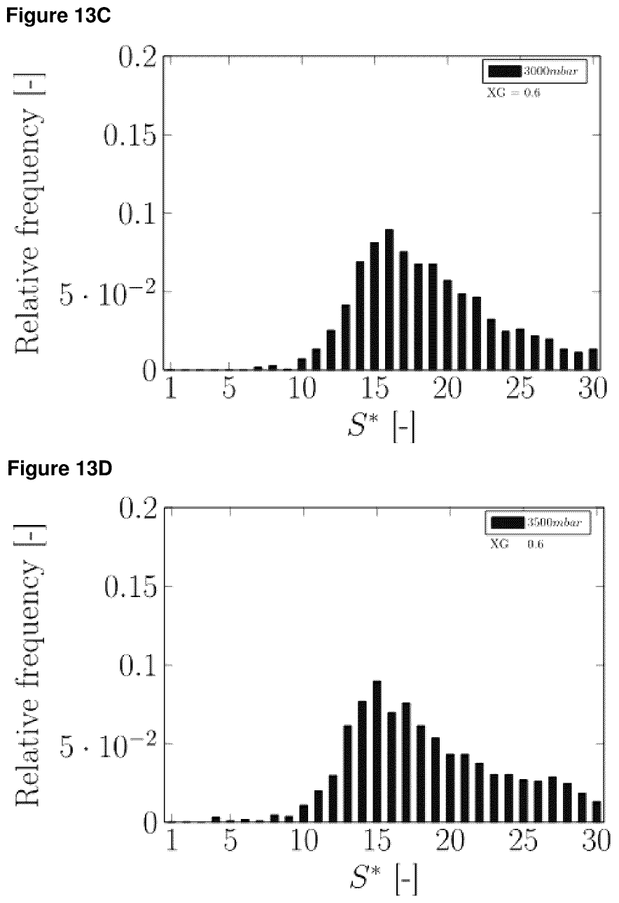

FIG. 13: Ordering in the long channel using 0.6 wt. % XG using different XG flow rates/pressure drops (Q). (a) Histogram of normalized inter-particle spacing, S*=s/d, XG flow effected by 2000 mbar pressure drop. (b) Histogram of normalized inter-particle spacing, S*=s/d, XG flow effected by 2500 mbar pressure drop. (c) Histogram of normalized inter-particle spacing, S*=s/d, XG flow effected by 3000 mbar pressure drop. (d) Histogram of normalized inter-particle spacing, S*=s/d, XG flow effected by 3500 mbar pressure drop.

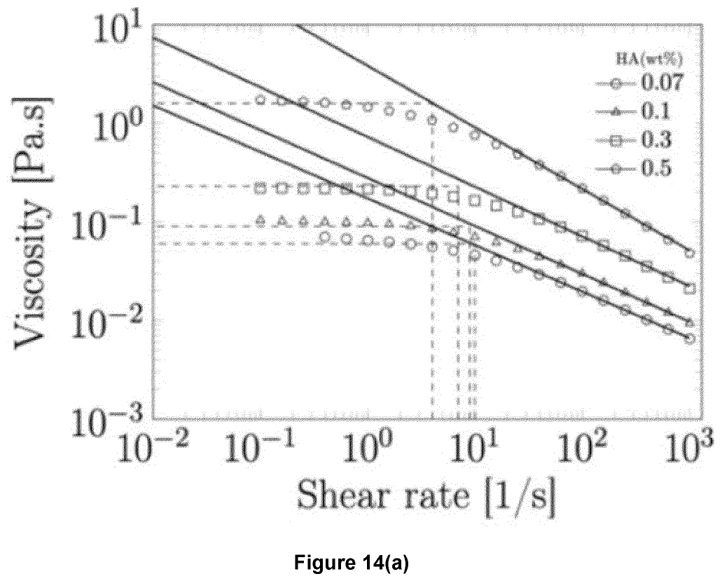

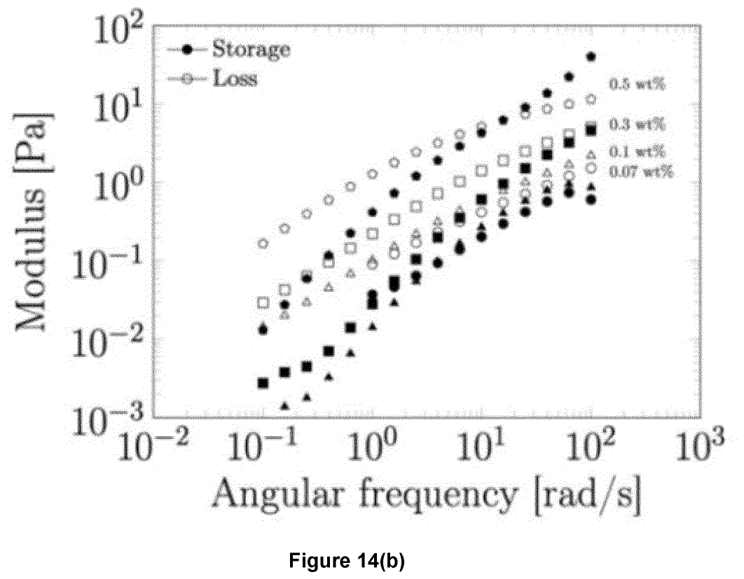

FIG. 14: Rheological characterisation of Hyaluronic Acid (HA) solutions at mass concentrations of 0.07, 0.1, 0.3 and 0.5 wt %. All the solutions display significant elastic properties. a) Shear viscosity of aqueous solution of HA as function of the shear. All the solutions display clear shear-thinning behaviour above a critical value of the shear rate evaluated as the intersection between the power-law fit applied in the shear-thinning regime and the straight line indicating the zero-shear-rate plateau. The inverse of the critical shear rate was employed to estimate the longest relaxation time of each solution. b) Storage and loss modulus obtained via small amplitude oscillatory shear tests with an imposed deformation of 5%. The two slopes represent the scalings for the storage and loss modulus the terminal region.

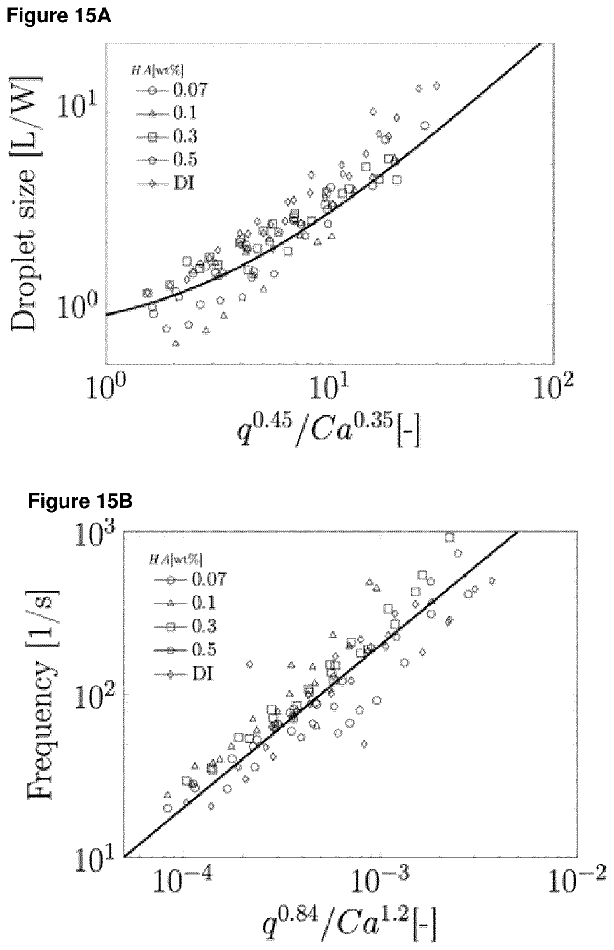

FIG. 15: a) Droplet size in Hyaluronic Acid as a function of the ratio q^{0.45}/Ca^{0.35}. Solid line has equation equation

$$\frac{L}{W} = 0.66 + 22 \times \frac{{q}^{0.45}}{C {a}^{0.35}} .$$

b) Droplet formation frequency as a function of the ratio q^{0.84}/Ca^{0.1.2}. Solid line has equation

$$f = 0.62 \times 1 {0}^{5} \times \frac{{q}^{0.84}}{C {a}^{1.2}} .$$

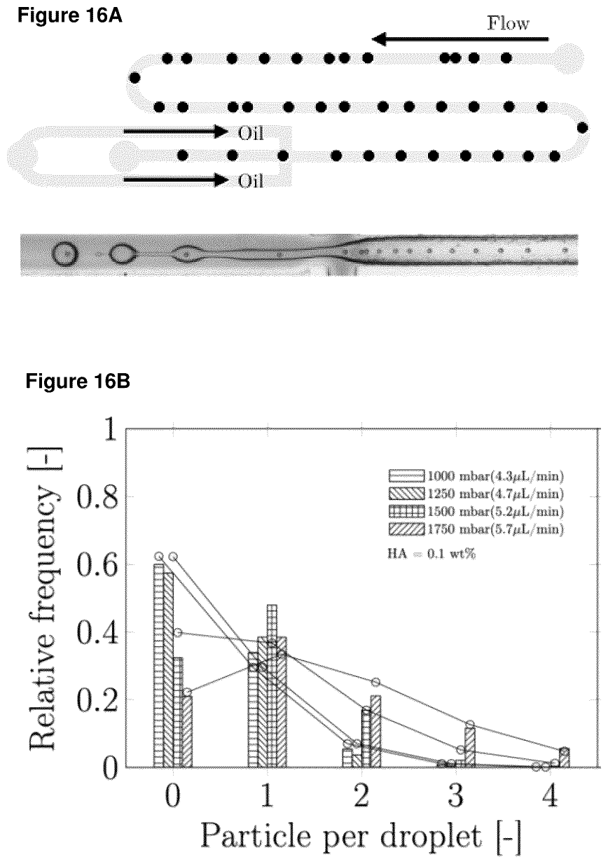

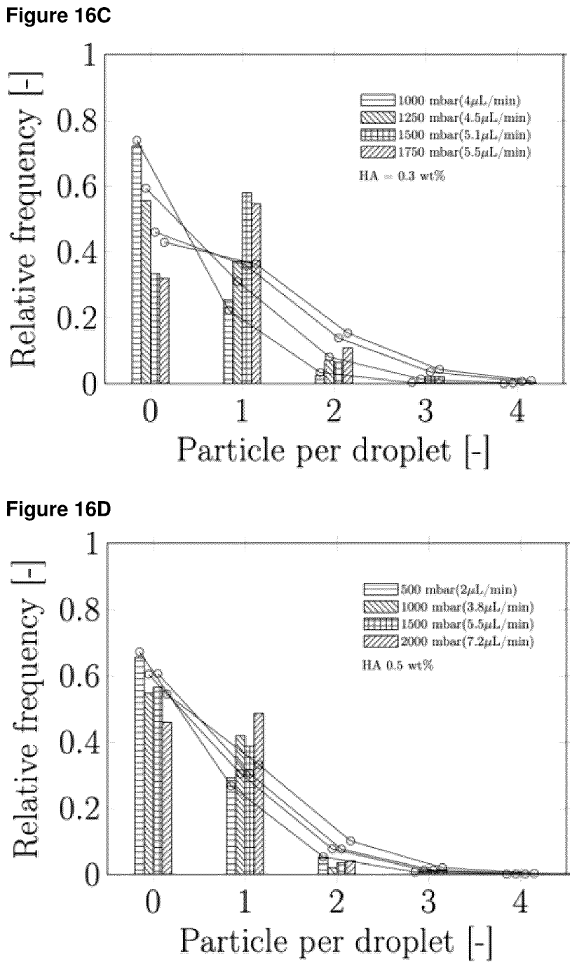

FIG. 16: a) Schematic of the encapsulation system employed for single encapsulation in Hyaluronic Acid (HA). HA solutions containing particles flow in the main channel, while mineral oil flows in the two lateral channel in a flow-focusing droplet formation geometry. b) Encapsulation efficiency in the viscoelastic HA 0.1 wt % (bars) compared to the Poisson prediction (symbol). c) same as b) for HA 0.3 wt %. d) Same as c) for HA 0.5 wt %.

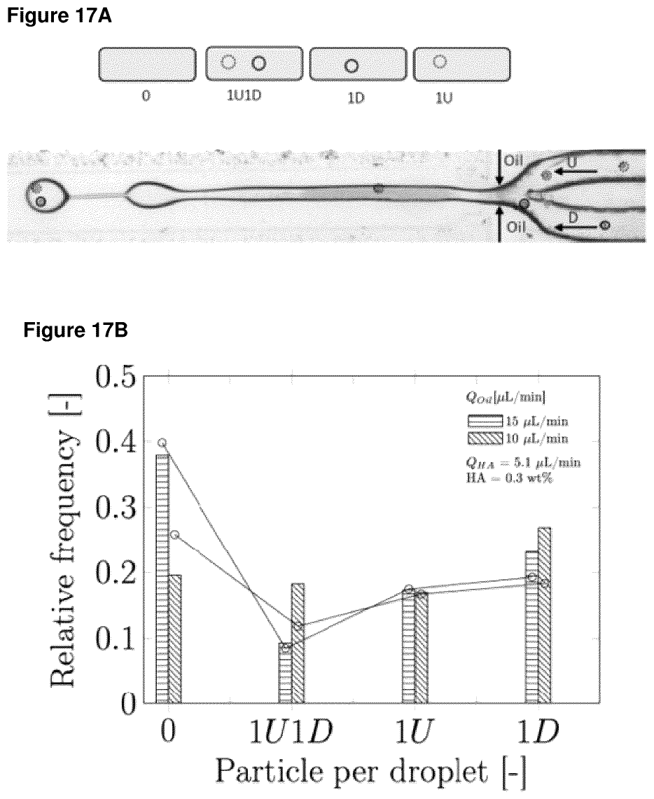

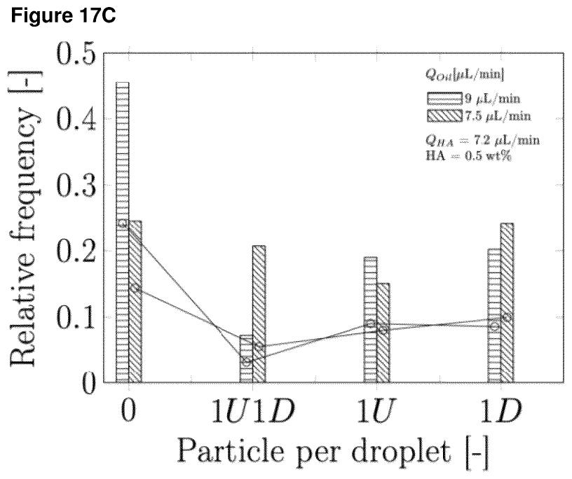

FIG. 17: a) Schematic of the co-encapsulation system in Hyaluronic Acid (HA) employed for double encapsulation. HA solution containing particles flow in the two main channels, while mineral oil flows in the two lateral channel in a flow-focusing droplet formation geometry. b) Encapsulation efficiency in the viscoelastic HA 0.5 wt % (bars) compared to the Poisson prediction (symbol). c) same as b) for HA 0.3 wt %.

### MICROFLUIDIC THEORY

The dynamics of a system of aligned particles suspended in a viscoelastic fluid and flowing in a microfluidic channel is a complex phenomenon. The hydrodynamic interactions between consecutive particles are mediated by fluid viscoelasticity, fluid dynamics conditions, and the characteristic dimensions of both the microfluidic device and the suspended particles. A variation of the relative position between two consecutive particles due to hydrodynamic interactions is reflected along the whole particle system with a characteristic time depending on several parameters such as the flow rate, particle over channel size, solid concentration and fluid rheology²³.

In the simplest case of a pair of particles aligned at the channel centreline, previous numerical simulations reported that particles experienced either an attractive or a repulsive force depending on their initial distance and the Deborah number De (definition of De is reported in Example 1 results below). For a Deborah number lower than a threshold De_{cr}, two particles with initial distance s below a critical value s_{cr} experience an attractive force, leading to the formation of a particle doublet (FIG. 1a). On the contrary, particles with initial distance s>s_{cr} experience a repulsive force that push the two particles apart (FIG. 1b). The value of the critical distance s_{cr} reduces for increasing values of the Deborah number (FIGS. 1c-1d) and, for values larger than De_{cr}, the two particles experience only a repulsive force. The attraction-repulsion dynamics between two particles depends on the rheological properties as well: shear-thinning features in the suspending liquid lead to a similar decreasing of the critical distance compared with near constant-viscosity liquids (FIGS. 1e-1f)^{27,28}.

For a system made of three aligned particles (depicted in FIG. 2), the dynamics becomes much more complex, now depending upon the two relative distances, say s₁ and s₂, and on the Deborah number De²⁷. For a Deborah number lower than the critical value De_{cr} and for at least one of the two relative distances lower than the critical value s_{cr}, the trailing and middle particle form a pair while the leading one moves faster and becomes isolated (FIGS. 2a-2c). Three isolated particles, on the contrary, are formed if the two interparticle distances s₁ and s₂ are both larger than the critical value s_{cr} (FIG. 2d). The latter is the only possible scenario for a Deborah number higher than De_{cr} (FIG. 2e).

In a system of several aligned particles, the overall dynamic depends upon the mutual distance between all the interacting particles. Since hydrodynamic interactions lead to continuous variations of the distances between two consecutive particles over time, the final configuration of the particle system cannot be easily predicted. However, according to the existing numerical simulations, particle trains (i.e. strings of equally-spaced particles) can be obtained when all the distances between consecutive particles in the aligned particle system are larger than the critical value s_{cr}. It is also possible that the continuity of the particle train is broken by the occurrence of particle multiplets (primarily doublets) formed because the initial distance between two particles is smaller than s_{cr}.

### EXAMPLES

### Example 1: Formation of Particle Trains

### Materials

Xanthan gum from Xanthomonas campestris was purchased from Sigma Aldrich Ltd. Polystyrene particles (diameter 20±2 μm) were purchased from Polysciences Inc.

### Methods and Characterization

A 0.1 wt. % Xanthan Gum (XG) solution was prepared by dissolving XG in deionised water. The solution was mixed using a magnetic stirrer for 12 hours to allow full dissolution of the polymer.

The rheological measurements were conducted on a stress-controlled rheometer (TA AR2000ex) with a truncated acrylic cone (60 mm diameter, 1° angle) at constant temperature of 22° C.). A home-made solvent trap was used to prevent solvent evaporation of XG solution during the rheological measurements.

The 0.1 w.% XG solution exhibited strong shear-thinning features in the shear rate region 10⁻¹<\dot{γ}<10³ s⁻¹ (FIG. 3a). At shear rate values lower than \dot{γ}≅1 s⁻¹, we observed an inflection of the viscosity as if the XG solution was attaining a constant zero-shear value. However, we were unable to explore experimentally the zero-shear region because the data appeared scattered, as affected by rheometrical edge effects.

There is a significant bulk of literature (see, for instance, Song et al.³⁰, Wyatt and Liberatore³¹ and references therein), where XG solutions in dilute and semi-dilute regime were extensively characterised and their elastic properties were found to be significant. Elasticity in XG solutions is due to their stiff rod-like behaviour in deionised water, similarly to aqueous solutions of rigid rods. Furthermore, the fact that, in our experiments, rigid particles suspended in XG 0.1 wt. % align on the centreline of the microfluidic device (see below) confirms that XG presents non-negligible elastic properties. In order to quantify the viscoelastic behaviour of the XG solution and to estimate the longest relaxation time A, we also performed small angle oscillatory shear (SAOS) rheological measurements, where the storage modulus G′ and the loss modulus G″ were evaluated as a function of angular frequency ω (FIG. 3b). Despite observing a distinct viscoelastic behaviour in the whole range of angular frequency investigated, we were unable to observe the ‘terminal region’ at low angular frequencies, where the data are expected to scale with slopes 2 and 1 for G′ and G″, respectively. Hence, we were not able to determine the longest relaxation time using standard SAOS measurements. A potential estimate for a relaxation time (not the longest one) could be performed as λ*≅1/ω_{c}=25 ms, where ω_{c}=40 rad/s is the frequency where G′=G″ in FIG. 3b. However, in agreement with previous works where the viscoelasticity was quantified using the longest relaxation time A, we estimated this parameter by fitting the viscosity curve of FIG. 3a with the Cross model:

$$μ = {μ}_{∞} + \frac{{μ}_{0} - {μ}_{∞}}{1 + {( 1 + λ \dot{γ} )}^{m}}$$

where μ_{→} is the infinite shear viscosity, μ₀ is the zero shear viscosity, A is the longest relaxation time, \dot{γ} is the shear rate and m is the factor that modulates the transition between the constant region and the shear-thinning region. The fitted parameters are: λ=1.59 s, μ₀=0.22 Pa·s, μ_{∞}=0.0018 Pa·s and m=0.61. In this example, we employed a value of the longest relaxation time equal to A=1.55 s to discuss our results.

Polystyrene particles (Polysciences Inc.) with diameter of 20±2 μm were added to the 0.1 wt. % XG polymer solution at four different mass concentrations of φ=0.2 wt. %, φ=0.25 wt. %, φ=0.3 wt. % and φ=0.4 wt. %. The resulting suspension was mixed using a vortex mixer (Fisherbrand ZX3) to fully disperse the polystyrene particles in the XG polymer solution. The suspension was further put in an ultrasonic bath for 2 minutes to remove potential aggregates.

### Microfluidic Apparatus and Particle Tracking

An inverted microscope (Zeiss Axiovert 135) was employed to analyse particle flow in a commercial hydrophilic glass T-junction chip (Dolomite, microfluidics) (see FIG. 4a). According to the manufacturer, the device presented a nearly circular cross-section having a height of 100 μm and a width of 110 μm with rounded corners. For the evaluation of the dimensionless Deborah number, we employed a value of the channel diameter equal to D=100 μm. The T-junction chip was connected to a 4-way Linear Connector (Dolomite, microfluidics), which was connected to an 8-mm Fluorinated ethylene propylene (FEP) tube (Dolomite, microfluidics) with an external diameter of 1.6 mm and an internal diameter of 0.25 mm. Videos of flowing particles were captured with a fast camera (Photron, fastcam Mini UX50) at a frame rate of 2000-4000 frames per second, depending on the imposed pressure drop. We selected a circular cross-section in order to reduce as much as possible the migration of particles towards the channel walls, which is observed in square-shaped channels and enhanced for strongly shear-thinning fluids (as employed in the present work).

The suspension was pumped at various pressure drops ΔP with a pressure pump (Mitos p-pump) and the evolution of the flow rate Q measured by the flow sensor (Dolomite microfluidics) was monitored using the pressure pump computer software (Dolomite microfluidics): the flow was considered to be stabilised once the value of Q reached a steady state.

The following experimental protocol was employed: First, a pressure drop corresponding to a flow rate Q=20 μL/min was imposed until the flow through the channel achieved steady-state. Then, the pressure drop ΔP was lowered to obtain a flow rate of Q=5 μL/min to record the videos. Thereafter, ΔP was increased and videos were recorded at resulting flow rate values of Q=7.5, 10, 15, 20, and 25 μL/min. The experimental videos were then analysed using a subroutine in order to derive the distance between consecutive particles (FIG. 4b). The distance between adjacent particles was measured from centre-to-centre and divided by the particle diameter to obtain normalised distance between particles, S*=s/d, where s is the centre-to-centre distance between adjacent particles and d is the particle diameter. Inter-particle distance histograms were then evaluated with (dimensionless) binning size equal to 1 and the two boundary ends were set to 1 and 64, which is the total length of the observation window (see FIG. 4b).

### Results

The results presented hereafter are discussed in terms of the Deborah number De that quantifies the degree of elasticity in response to the flow deformation. In agreement with previous works²², we defined De as:

$$De = \frac{4 λ Q}{π {D}^{3}}$$

where Q is the volumetric flow rate, λ is the longest relaxation time and D is the diameter of the microfluidic channel. For Newtonian fluids, the relaxation time is zero (instant relaxation), and therefore, De=0. For non-Newtonian fluids, the Deborah number is always positive.

### Particle Focusing is the ‘Prelude’ to Train Formation

Particle ordering, either in inertial of viscoelastic flows, requires that adjacent flowing particles interact hydrodynamically with each other²⁷. This condition is fulfilled when the particle concentration is sufficiently large to make hydrodynamic interactions relevant between consecutive particles. Furthermore, longitudinal train formation requires that the particles be aligned along one streamline of the flow field. The experimental evidence provided by Del Giudice et al.⁸ suggested that self-assembly of particle trains is obtained only when the suspending liquid displays shear-thinning features; otherwise, adjacent particles will experience a substantial attractive force that would result in particle string formation rather than particle trains. In Newtonian liquids under inertialess conditions, particles do not focus nor self-order, as also experimentally observed here (data not shown). To focus particles on the centreline of the microfluidic device in shear-thinning liquids, Del Giudice et al.²² demonstrated that the confinement ratio β=d/D should be β≥0.15. For lower values of the confinement ratio, instead, particles were driven towards the lateral walls of the microfluidic device²². As previously reported, in our experiments, we employed an aqueous Xanthan Gum 0.1 wt. % shear-thinning solution (FIG. 3a) and particles with diameter d=20 μm flowing in a microfluidic channel with tube diameter of D=100 μm, thus leading to a value for the confinement ratio ß=0.2.

Polystyrene particles at two bulk concentrations of φ=0.2 wt. % and φ=0.3 wt. %, at a (dimensionless) distance from the channel inlet LID=400, corresponding to 4 cm from the inlet of the microfluidic device, were perfectly focused on the channel centreline (snapshots in FIGS. 5a and 5b). However, they were not equally-spaced, as confirmed by the S*=s/d distribution at different Deborah number values

The only peak in the probability function at LID=400 was the one at S*=1, meaning that several particles were forming strings of particles in contact, which were found to be mainly doublets (data not shown). Doublet formation could be ascribed to the multiple connections existing between the reservoir and the microfluidic channel, all of them with different internal diameters. Intuitively, when a large concentration of particles experience a series of significant geometrical contractions and expansions, particle overcrowding might occur between consecutive connections, resulting in doublet formation.

As the distance between consecutive particles becomes smaller than a critical value, recent numerical simulations^{27.28} predicted that the particles experience an attractive force leading to doublet formation; a similar phenomenon has been observed experimentally by Del Giudice et al.⁸. We did not have direct optical access to the different connections, therefore, we could not make a clear conclusion on this point. However, the fact that the strings of observed particles tended to form mostly doublets seem to support our hypothesis rather than suggesting an intrinsic particle self-assembly dynamic influencing the whole train. Notably doublets or triplets formation involved only a maximum of 20% of the overall number of particles (data not shown), while the remaining 80% was made of isolated particles.

These results showed that the particles focused relatively quickly (UID=400) even though no clear self-assembled structure could be observed (FIGS. 5a and 5b), apart from doublets or triplets. Since particle trains were observed at LID=2500 as described in detail below, this suggest that particle focusing occurs prior to particle ordering, in agreement with previous studies on viscoelastic and inertial ordering.

### Train Formation in a Shear-Thinning Xanthan Gum Aqueous Solution

As shown above, we observed particle focusing on the channel centreline at LID=400, despite no clear ordering occurring (FIGS. 5a and 5b). When moving the observation point towards the outlet of the microfluidic device at LID=2500 (corresponding to a distance from the channel inlet of 25 cm), significant peaks in the distribution of S* appeared, regardless of the Deborah number (FIGS. 5c and 5d), denoting the existence of a preferential interparticle distance and the formation of a particle train.

For a particle concentration of φ=0.2 wt. %, the peaks in the distributions at LID=2500 (FIG. 5b) were between 7<S*<8 for all the Deborah numbers investigated, in agreement with the experimental results of Del Giudice et al.⁸ where the interparticle distance was found to be independent of De. Since the average distance computed from the distributions at LID=400 (FIG. 5a) was about 7 particle diameters, we concluded that at LID=2500 a good degree of ordering was obtained with a preferential distance consistent with the equilibrium one (i.e., the one expected if all the particles were equally-spaced).

It is also notable that, for increasing values of De, the preferential distance moved from S*=7 to S*=8 and, accordingly, the peak at S*=1 increased (data not shown). However, this behaviour can be easily understood as, by increasing the number of particles that form doublets or triplets (those at S*=1), the equilibrium distance of the particles in the train must increase. Taken together, these observations suggest that the equilibrium distributions at LID=2500 is unaffected by the Deborah number and the slight deviations are due to the presence of a different amount of particles forming strings that, in turn, depends on the initial interparticle distances.

A different phenomenon was instead observed for the higher particle concentration o=0.3 wt. %, where a peak in the interparticle distance distribution was still clearly visible but at a value of S* that strongly depended on the Deborah number (FIG. 5d). Specifically, the peak progressively moved at higher interparticle distances as De increases, in agreement with recent numerical simulations²³. A possible explanation for this behaviour is that the particle train did not reach a stable regime yet, i.e., by further increasing the distance from the channel inlet, the distributions in FIG. 5d would change. As previously shown²³, the train dynamics is strongly affected by any interparticle distance variation that is more relevant at high particle concentrations as the particles are on the average closer, enhancing the hydrodynamic interactions.

The distributions reported in FIG. 5 also showed the existence of a relevant peak at S*=1 denoting the formation of doublets and triplets of particles in contact. Such a peak, observed for all the investigated conditions, was also present relatively close to the channel inlet (LID=400), suggesting that this was a phenomenon related to the initial particle distribution rather than an effect of the particle ordering. As previously reported by numerical simulations^{23.27}, once two aligned particles achieved a distance smaller than a critical value, fluid viscoelasticity generated an attractive force leading to doublet formation. The particles forming the doublet could be hardly separated during the flow. This was confirmed by our experimental distributions where (except the peculiar case at φ=0.2 wt. % and De=165) the peak at S*=1 remained nearly constant or increased from LID=400 to UID=2500. Needless to say, the formation of doublets/triplets is detrimental for particle ordering and should be avoided. In this regard, designing a microfluidic device with more complex geometries aimed at increasing the distance between close particles might help. An example of such device was recently reported by Liu et al.20, where a complex serpentine-like microfluidic channel was developed to prevent doublet and/or triplet formation.

### Discussion

This work demonstrated that a viscoelastic shear-thinning aqueous 0.1 wt. % Xanthan Gum solution promoted the self-assembly of particle trains on the centreline of a serpentine microfluidic device. Further the particles were shown to be focused relatively quickly (LID=400), even though no clear self-assembled structure could be observed. Particle train formation was found at LID=2500, thus making particle focusing the ‘prelude’ to particle ordering.

The preferential distance observed through the distributions of the interparticle distances depended on the particle concentration and the Deborah number. The distributions were also characterized by a significant peak at a distance equal to the particle diameter, denoting the presence of several particles forming doublets or triplets. These were ascribed to the fact that adjacent particles with initial inter-particle distances below a critical value were subjected to viscoelasticity-mediated attractive forces and were hardly separated during the flow.

Since the existence of these structures is detrimental for particle ordering, new channel designs and separation methodology needed to be developed to avoid/reduce their formation.

### Example 2: Controlled Encapsulation of Particles

### Methods and Characterization

Aqueous Xanthan Gum (XG) solution in range of 0.05 to 0.6 wt. % was prepared by dissolving Xanthan gum from Xanthomonas campestris (obtained commercially from Sigma Aldrich) in deionized water and applying magnetic stirring for 12 hours to allow full dissolution of the polymer. The shear viscosity of aqueous solution was measured on a stressed control Rheometer (TA AR-G2) with a double-gap geometry at constant temperature (T=22° C.). Mineral oil (Sigma Aldrich, UK) was used as the continuous phase in droplet generation and encapsulation experiments. A non-ionic surfactant, 1 wt. % Sorbitan monooleate (Span® 80), was added to stabilize the interface between XG and mineral oil phase. Interfacial tension between two immiscible fluids was measured using a force tensiometer (Sigma 702, biolin Scientific). Addition of surfactant drastically decreased interfacial tension, independent of XG concentration, between two phases from 19±0.1 mN/m to 3.4±0.1 mN/m.

Polystyrene particles (Polysciences Inc) with diameter d of 20±2 μm at concentration of 0.3 wt. % was added to XG. Then, the suspension was mixed using a vortex mixer (Fisher-brand ZX3) to fully disperse the polystyrene particles in the XG solution. The suspension was further put in an ultrasonic bath for 2 minutes to remove potential aggregates prior to performing encapsulation experiments.

### Experimental Setup

A commercial hydrophobic glass T-junction chip (Dolomite, microfluidics) (see FIG. 4a) of circular cross section of diameter D=100 μm was mounted on an inverted microscope and videos of droplet generation/particle encapsulation were captured at frame rate of 2000-4000 with a high-speed camera (Photron, fastcam Mini UX50). For droplet generation continuous and dispersed phase liquids were pumped into the chip using a syringe pump (kd Scientific). The captured videos were analysed using a home made code written in MATLAB to determine size and frequency of droplet generation. For particle encapsulation experiment, a particle tracking algorithm was employed upstream of the T-junction to analyse particle flow, prior to reaching the encapsulation region, to measure inter-particle spacing, size, and velocity of the particle. At the T-junction we were able to obtain number of particles per droplet for encapsulated particles using image analysis.

### Dimensionless Parameters

It is generally understood that the properties of two immiscible fluid flows that determine droplet size are interfacial tension coefficient γ, dynamic viscosity of dispersed and continuous phases μ_{d} and μ_{c}, and flow rates of two phases Q_{d} and Q_{c}, where subscript d and c refer to dispersed and continuous phase, respectively. Q_{d} and Q_{c} are used interchangeably with Q and Q′, respectively, throughout this application. These parameters are usually used in their normalized forms as Q=Q_{d}/Q_{c}, η=μ_{d}/μ_{c}, and Ca=μ_{c}U_{c}=γ; here U_{c}=4Q_{c}/πD₂ is the average velocity of continuous phase fluid. In our experiments, continuous phase viscosity was measured to be 29 mPa·s and the flow rates was changed in range of 0.1-10 μL/min corresponding to capillary number in range of Ca [0.001-0.1]. For this range of control parameters, the Reynolds number of continuous phase Rₑ=ρ_{c}U_{c}D/μ_{c} is 6:4×10⁻⁴-6:4×10⁻². Weissenberg number, Wi=λ\dot{γ} ratio of fluid relaxation time and characteristic time scale of flow(1/), is used to describe the degree to which nonlinearity is exhibited in viscoelastic fluids. Characteristic time scale of dispersed phase was estimated by the apparent wall shear rate for a Newtonian fluid 1/\dot{γ}=32Q_{XG}/πD³ with D being the channel diameter and relaxation time(A) was obtained from FIG. 6a.

### Results

FIG. 6a shows shear viscosity for XG as a function of shear rate for different concentrations. The XG exhibited a strong shear-thinning behaviour in the range of applied shear rates(10⁻²<\dot{γ}<10³ 1/s) for all concentrations. At low shear rates, XG showed a Newtonian plateau and a transition to a shear thinning power-law region was detected as the shear rates was further increased. As the concentration of XG was increased, zero-shear viscosity increased and transition point form first Newtonian plateau to power-law region started at lower shear rates. Simple amplitude oscillatory shear (FIG. 6b) measurements were performed to characterize viscoelastic properties of fluids. Despite observing a distinct and pronounced viscoelastic behaviour, we were unable to observe terminal region at low frequencies where storage and loss modulus are proportional ω² and ω, respectively. Hence, we were not able to determine the longest relaxation time using standard SAOS measurements. Instead, relaxation time was estimated from the viscosity verses shear rate data by determining the intersection of the power-law fit to the shear thinning regime and the least squares fit to the first Newtonian plateau. A relaxation time of 7.7, 10.36, 14, 16, and 22.5 s was estimated for XG concentrations 0.05, 0.1, 0.2, 0.3, and 0.6 wt. %, respectively.

### Viscoelastic Droplet Generation

Previous studies on droplet generation in microfluidic devices, mostly focused on the Newtonian fluid, have identified three regimes: squeeze, dripping, and jetting. In the squeeze regime, at low capillary numbers, interfacial stresses dominate the shear stresses. The dynamics of break-up of immiscible fluids in this regime is dominated by the pressure drop developed across the droplet and size of the droplets is determined by the ratio of the volumetric rates. In the dripping regime, high capillary numbers (Ca>0.01), viscous stress dominates over interfacial stresses and droplet size follows a power-law relationship with capillary number.

However, little is known about the role of non-linear properties such as fluid viscoelasticity and shear-thinning of the dispersed phase. We investigated the mechanism of break-up, and scaling characteristics of XG droplet generation in microfluidic T-junctions over a wide range of concentration and flow rates. In the T-junction microfluidic, two immiscible liquids flow into separate inlet channels that intersect at right angles. XG solution emerges into the junction and enter the main channel and confines the flow of the carrier fluid (see FIG. 7a). We observed that XG thread started to elongate in the channel then thinned quickly and formed a primary droplet connected to a thin filament. The thin filament finally pinched off to form satellite droplets. We observe that by increasing the continuous phase flow rate, fluid only partially fills the main channel, and that the breakup point moves downstream of the T-junction. FIG. 7b) show normalized droplet size, ratio of droplet length to channel diameter, for different concentration of XG. Our data show a good agreement with previous relationship proposed for squeeze regime for Newtonian fluid. Previous numerical studies on non-Newtonian droplets, found that the strongest effects on the droplet size come from the continuous phase properties and flow rate, the interfacial tension, and the contact angle. The effect of the disperse phase rheology is manifested in the viscosity ratio, which has as a direct effect on the droplet diameter. However, differences between the fluids become smaller because stronger shear thinning in the more concentrated fluids narrows the difference in effective viscosity at higher flow rates. Droplet size decreases with continuous to dispersed viscosity ratio. We elucidate that at high capillary and dispersed flow rate the effect of shear thinning narrows the difference in effective viscosity at higher flow rates, thus, contributes to smaller droplet size variation. This idea is supported by our data since we did not find a strong dependence of droplet size with concentration.

The frequency of droplet formation was measured by measuring time period between formation of two consecutive drops and averaged over total number of detected droplets. Frequency was proportional to continuous and dispersed phase flow rate and independent of XG concentration. In the squeezing regime, frequency increases with growing Q_{d} suggesting that increasing dispersed flow rate can accelerate the expansion, squeezing, and necking of the dispersed phase. However, droplet normalized length (see FIG. 7b) is also increased by increasing Q_{d} at constant Q_{c}, that is, LID increases when droplet generation is accelerated. Our observation is in good agreement with previous works on Newtonian fluid⁴⁷. FIG. 7c shows frequency of droplet formation as a function of fluids flow rates product. Interestingly, data points collapse on a master curve of form f=A(Q_{XG}Q_{Oil})^{B} and A=9.22 and B=2/3 we obtained from fitting for flow rates in range of 0.3-9 μL/min.

Although, we observed continuous generation of viscoelastic XG drops, there is an upper limit to dispersed phase flow rate for stable droplet generation at each Ca number. By increasing the dispersed phase flow, size of droplet increased monotonically, however, at a critical flow rate(Q*_{d}) the droplet generation became unstable and lead to parallel flow of two immiscible fluids. The transition point was proportional to the continuous phase flow rate and inversely proportional to XG concentration. Shown in FIG. 7d the critical Weissenberg number, calculated from critical dispersed flow rate, collapse on a master curve for different concentrations.

### Particle Encapsulation

Droplet microfluidics provides a platform technology for encapsulation of particles/cells in mono-disperse aqueous droplets that are suspended in an immiscible oil carrier fluid. Microfluidic droplets provide the means to achieve various high-throughput single-cell assays, such as biochemical reactions and cell-cell interactions in picoliter droplets. Encapsulation of single particle or co-encapsulation of a cell and a functionalised particle is desired in many applications such as drop sequencing.

In randomly dispersed particles, Poisson's statistics describes the probability of a drop containing n particles is n^{k} exp(−k)/(n!), where k is the average number of particles per drop⁴⁸. If the average number of particles is k=1, the probability of one particle per droplet is 36%. Therefore, outperforming the Poisson's statistics is crucial for maximizing the efficiency of encapsulation and drop-sequencing applications.

Our results on particle ordering (see Example 1) using XG provide a route to increased performance of such applications. We studied particles encapsulation by flowing 0.3 wt. % PS particle suspension into the microchip using two inlets: short inlet of nearly 4 cm and the long channel is 25 cm. In the case of short inlet, shown in inset in FIG. 8, suspension flows to the junction and meets the cutting fluids that flow in the longer inlet at the junction that lead to loading particles into droplet. A distribution of the number of encapsulated particles was obtained from image analysis by counting the number of particles in each droplet from hundreds of droplets. FIG. 8 shows that probability of number of particles per drop was highest for empty droplets and decreased monotonically for higher particle per droplet numbers. In these experiments, particle per droplet frequency was dictated by the Poisson statistics (solid lines in FIG. 8) which is attributed to stochastic particle loading. We observed that particles arrived at the encapsulation region randomly spaced and few aggregates of particle in form of doublet and triplets were encapsulated. This provides the first evidence of particle encapsulation using viscoelastic fluids in microfluidic devices.

As shown in Example 1 above, non-Newtonian properties of XG solution can be used to focus and then order particles on the channel centreline. We used the same approach by flowing the suspension in the long channel and the cutting fluid was pumped from the short channel. FIG. 9a shows the distribution of normalized inter-particle spacing(S*), inter-particle distance normalized by particle diameter of particle, at the upstream of the encapsulation area. Formation of aggregates of particle is denoted by S*=1 and S*≥2 signifies individual particles. The distribution exhibit significant peaks, indicating existence of a preferential inter-particle distance and the formation of a particle train; low probability of S*=1 indicates that most particle are present as single, isolated, particles. The distribution of particles per droplet shown in FIG. 9b, which shows that use of the long channel inlet for particle separation before arrival at the encapsulation area outperforms the Poisson's statistic (solid line) by achieving an increase in probability of single particle per droplet and a decrease in probability for empty droplets and droplets containing multiple particles. In particular, the observed encapsulation efficiency was around 15% higher than expected on the basis of Poisson's statistics.

### Example 3: Optimization Particle Separation and Single Particle Encapsulation

The particle encapsulation tests of Example 2 were replicated whilst varying xanthan gum concentration and flow rates to assess the effect of same on the particle separation and encapsulation process.

As the results in Example 2 (see FIG. 8) demonstrate that a short channel length (e.g. L/D 400) is insufficient to achieve particle ordering (and so encapsulation efficiency was Poisson like), all tests in this example were carried out by flowing the XG suspension in the long channel and the cutting fluid was pumped from the short channel of the T-junction chip as shown in FIG. 9.

In a first series of tests, a 0.05 wt. % XG solution was used to suspend the particles and the mixture was passed through the microchannel at varied flow rates. The results of these tests, which are provided in FIG. 10, clearly show that whilst all tested flow rates resulted in droplet formation, the particles were not equally spaced and so single particle encapsulation efficiency was poor.

Therefore, an analogous test using a 0.1 wt. % XG solution was conducted, the results of which are provided in FIG. 11. Notably, these results show suboptimal particle separation with the formation of large particle aggregates (FIG. 11a), which resulted in a single particle encapsulation efficiency below that expected on the basis of Poisson's statistics. Notably, these results compare poorly with those presented in Example 2 using 0.2 wt. % XG (FIG. 9), in which the observed encapsulation efficiency was around 15% higher than expected on the basis of Poisson's statistics.

The tests were also replicated using a 0.3 wt. % XG solution, the results of which are shown in FIG. 12. Notably, these results clearly show that zero or very few multi-particle per droplet encapsulation was observed, with observed encapsulation efficiency being around 25% higher than expected on the basis of Poisson's statistics. Moreover, further improvements were observed as the pressure drop (and so flow rate) was increased. These improvements were attributed to improved particle ordering, manifesting itself in clear peak with higher probability in inter-particle spacing histograms (FIGS. 12a and c).

Finally, the tests were replicated using a 0.6 wt. % XG solution, the results of which are shown in FIG. 13. Notably, such a solution can be used for good particle separation avoiding the formation of large particle aggregates. However, to do so high flow rates had to be employed, which would prevent the encapsulation of separated particles due to flow instability between the oil and xanthan gum phases (see FIG. 7d).

### Discussion

This work demonstrates that xanthan gum (XG) concentration should be carefully selected to optimise both the spacing of particles (minimizing doublet and triplet formations) and the formation of encapsulating droplets.

In particular, 0.05 wt. % XG may be used to form droplets but inferior particle spacing was observed, resulting in the inconsistent production of single particle encapsulating droplets. Similarly, the use of 0.1 wt. % XG resulted in the formation of large aggregates which resulted in single particle encapsulation with an efficiency lower than that predicted by Poisson's statistics. Further, the use of 0.6 wt. % XG was shown to provide excellent particle spacing (minimizing doublet and triplet formation), but particle encapsulating droplets could not form due to flow instability.

However, good particle spacing and improved single particle encapsulation efficiency was achieved using 0.2 wt. % or 0.3 wt. % XG. Specifically, 0.2 wt. % XG (see Example 2) has been shown to separate particles, although some large particle aggregates remained (see FIG. 9). Nevertheless, the single particle encapsulation efficiency was observed to be around 15% higher than Poisson. Moreover, a higher single particle encapsulation efficiency, approximately 25% higher than expected based on Poisson's statistics, was observed using 0.3 wt. % XG as the separation fluid.

### Example 4: Particle Encapsulation in Hyaluronic Acid

### HA Preparation and Characterisation

An aqueous solution of Hyaluronic acid (HA) in range of 0.07 to 0.5 wt % was prepared by dissolving HA (Sigma Aldrich, UK) in deionised water and the solution was stirred using a magnetic stirrer for 12 hours to allow full dissolution of the polymer. Rheological properties of HA was measured on a stressed control Rheometer (TA, AR-G2) with a cone-plate geometry(1°) at constant temperature of T=22° C. Rheological characteristics of HA solution exhibited strong shear-thinning behaviour in the range of applied shear rates for all the concentrations (FIG. 14a). At low shear rates, HA showed a Newtonian plateau and a transition to a shear-thinning power-law region was detected as the shear rates was further increased. As the concentration of HA was increased zero-shear viscosity increased and transition to power-law region started at lower shear rates. Viscoelastic properties of the solution were characterised by performing Simple amplitude oscillatory shear (SAOS) measurement (FIG. 14b). Despite observing a distinct and pronounced viscoelastic behaviour we were unable to observe terminal region at low frequencies. Hence, we were not able to determine the longest relaxation time using standard SAOS measurements. Relaxation time was estimated from the viscosity versus shear rate data of FIG. 14 by determining the intersection of the power-law fit to the shear-thinning regime and the least squares fit to zero-shear plateau. Relaxation time values of 0.1 s, 0.11 s, 0.143 s, and 0.25 s were obtained for concentrations of 0.07, 0.1, 0.3 and 0.5 wt %, respectively. For the continuous phase Mineral oil (Sigma Aldrich, UK) was used in droplet generation and encapsulation experiments. A non-ionic surfactant, Span 80 1 wt % (Sigma Aldrich, UK), was added to the oil phase to stabilize the interface between HA and mineral oil phase. Interfacial tension between two immiscible fluid was measured using a force tensiometer (Sigma 702, biolinscientific) using du Nouÿ ring method. Table I shows interfacial tension between HA solution and mineral oil.

Polystyrene particles (Polysciences Inc.) with diameter d=20±2 μm were added to HA, then, suspension was mixed using a vortex mixer (Fisherbrand ZX3) to fully disperse the polystyrene particles in the HA solutions. The suspension was further put in an ultrasonic bath for 2 minutes to remove potential aggregates prior to performing experiments.

TABLE 1
Interfacial Tension in Mineral oil with Span 80 1 wt %

| HA concentration | Interfacial Tension [mN/m] |
|---|---|
| 0.07 | 3.63 ± 0.07 |
| 0.1 | 3.64 ± 0.05 |
| 0.3 | 3.04 ± 0.16 |
| 0.5 | 1.65 ± 0.08 |

### Experimental Setup

A home-made chip with flow-focusing geometry of rectangular cross section W=H=100 μm was made out of polymethyl methacrylate (PMMA). The PMMA sheet were milled using a CNC milling machine (Minitech machinery corporation, US) to form three walls of the microchannel. Then, the microchannel was bonded to a glass slide using a pressure sensitive double-side tape (Adhesives Research Ire-land Ltd). The chip was mounted on an inverted micro-scope (Zeiss Axiovert 135) and videos of droplet generation/particle encapsulation were captured at frame rate of 250-4000 fps with a high speed camera(Photron, fastcam Mini UX50). The channel downstream of the encapsulation area featured a height H=100 μm and a width W=120 μm.

The captured videos were analysed using a code written in MATLAB to determine size and frequency of droplet generation. In encapsulation experiments droplet were detected automatically using the home image analysis code and number of particles per each droplet was manually counted. For particle encapsulation experiment, a particle tracking algorithm was employed to the upstream of the junction to analyse particle flow, prior to reaching the encapsulation region, to measure inter-particle spacing, size, and velocity of particle.

### Results and Discussion

### Generation of Droplets

HA is used as the dispersed phase and Mineral oil as the continuous phase for droplet generation. HA enters the main channel from the right inlet while mineral oil, as the continuous phase, enters the main channel vertically via the top and bottom inlets.

The formation of droplets is divided into three stages: filling stage, necking stage and detachment stage. The formation of droplets is mainly that the continuous phase has flow-focusing effect on the dispersed phase. There are roughly three regimes for droplet generation called squeezing, dripping and jetting. The capillary number Ca, the flow rate ratio of the two phases q, the viscosity of the continuous phase, and the interfacial tension between the two phases have very important influence on the droplet formation regime and subsequently droplet size.

The droplet length can be predicted considering the influence of the Capillary number Ca and the flow rate ratio q. Previous studies on Newtonian droplets reported that for flow-focusing geometry the normalised droplet length L/W, where L is the droplet length and W is the channel width, scales as:

$$\frac{L}{W} = a + ϵ \frac{{q}^{b}}{{Ca}^{c}} .$$

FIG. 15a shows the normalised droplet size(L/W) as a function of dimensionless numbers Ca and q. For droplet size, the data collapse on a master curve scaling with

$$\frac{{q}^{b}}{C {a}^{c}}$$

and exponents obtained from fitting was found to be 0.45±0.01 and 0.35±0.01 for b and c, respectively. To reach the goal of maximising the efficiency of single/co-encapsulation of particle we should know the frequency and size of the droplet. This frequency should be synchronised with the frequency of particles approaching the focusing area. A similar master curve (FIG. 15b) could be used for frequency:

$${f}_{d} = α \frac{{q}^{m}}{C {a}^{n}}$$

α=2.00±0.02×105[1/s], m=0.84±0.05 and n=1.20±0.05 was obtained from the fitting. The droplet generation frequency fa should match particles frequency (fₚ) to maximise the encapsulation efficiency.

### Controlled Encapsulation of Particles in HA

To achieve controlled encapsulation, an ordering a channel of length 30 cm is placed upstream of a droplet-generating area. We observed that particles arrived at the encapsulation region focused at the centreline and with preferential spacing, with very few aggregates of particles in the form of doublets and triplets, that were subsequently encapsulated. When the process of loading particles into drops is purely random Poisson statistics predicts probability of droplets containing n particles is:

$$P = \frac{{k}^{n} exp ( - k )}{n !} ,$$

Where k is the average number of particles in the droplet. FIG. 16 compares the efficiency of single-encapsulation to Poisson statistics for different HA concentrations. The data shows that for HA in range of 0.1-0.5 wt % the probability of droplet with single particle was higher than Poisson statistics. For each HA concentration, we observed a non-monotonic behaviour for encapsulation efficiency with a unique combination of parameters in which the single encapsulation efficiency was the highest possible. This is expected since synchronization of particle ordering and droplet formation (fp=fd) could potentially lead to a deterministic (100% efficiency) encapsulation.

### Controlled Co-Encapsulation of Particles in HA

The co-encapsulation of particles was studied by introducing a second inlet to the encapsulation design (see FIG. 17a). The two stream of dispersed phase, here referred as type U and type D, met at the junction and continuous phase cut the HA to form droplets. FIG. 17a depicts a schematic representation of co-encapsulation chip used in the experiments. The Poisson probability for co-encapsulation where a droplet contains no particles of type D and nu particles of type U is then given by the product of the two independent Poisson probabilities as:

$$P = \frac{{k}_{U}^{{n}_{U}} exp ( - {k}_{U} )}{{n}_{U} !} \times \frac{{k}_{D}^{{n}_{D}} exp ( - {k}_{D} )}{{n}_{D} !}$$

here k_{U} and k_{D} are the average number of particles per droplet for particles type U and type D, respectively. Poisson statistics for average number of particles per droplet equal to 1 (k_{U}=k_{D}=1) predicts probability of 13.5% for one-to-one co-encapsulation (n_{U}=n_{D}=1). FIG. 17b-c compares the efficiency of co-encapsulation with the Poisson statistics value. For HA 0.5 wt % and at constant dispersed phase flow rate Qc=7.2 μL/min, Qc=9 μL/min produced high number of empty droplets (P=45%) and one-to-one encapsulation (1U1D) was dictated by the experimentally predicted Poisson statistics. By reducing the Qc to 7.5 L/min the number of empty droplets was reduced to nearly 25% and one-to-one efficiency (1U1D) rose to 22%, 63% higher than Poisson statistics. This is attributed to the better synchronization of particles and droplet frequency. Similar tendency was observed for HA 0.3 wt % as reducing the Qc from 15 to 10 μL/min the on-to-one encapsulation efficiency increased to 20% under Qd=5.2 μL/min. We obtained our statistics by counting at least 650 droplets.

### SUMMARY

We have shown that a viscoelastic shear-thinning aqueous Xanthan Gum solution and Hyaluronic acid can drive the self-assembly of ‘particle trains’ on the centreline of a microchannel that are characterized by a preferential spacing. Furthermore, by carefully selecting channel design and flow rate, we were able to reduce the occurrence of multi-particles, mainly doublets and triplets, that interrupt the continuity of the particle train.

Moreover, we were also able to combine such optimized particle trains with an immiscible oil flow to successfully encapsulate separated particles, and co-encapsulate a plurality of populations of separated particles, in droplets.

### REFERENCES

(8) Del Giudice, F.; D'Avino, G.; Greco, F.; Maffettone, P. L.; Shen, A. Q. Fluid viscoelasticity drives self-assembly of particle trains in a straight microfluidic channel. Phys. Rev. Applied 2018, 10, 064058.
(20) Liu, L.; Xu, H.; Xiu, H.; Xiang, N.; Ni, Z. Microfluidic on-demand engineering of longitudinal dynamic self-assembly of particles. Analyst 2020, 145, 5128-5133.
(22) Del Giudice, F.; Sathish, S.; D'Avino, G.; Shen, A. Q. “From the edge to the center”: viscoelastic migration of particles and cells in a strongly shear-thinning liquid flowing in a microchannel. Anal. Chem. 2017, 89, 13146-13159.
(23) D'Avino, G.; Maffettone, P. L. Numerical simulations on the dynamics of trains of particles in a viscoelastic fluid flowing in a microchannel. Meccanica 2020, 55, 317-330.
(27) D'Avino, G.; Hulsen, M.; Maffettone, P. Dynamics of pairs and triplets of particles in a viscoelastic fluid flowing in a cylindrical channel. Comput. Fluids 2013, 86, 45-55.
(28) D'Avino, G.; Maffettone, P. L. Numerical simulations on the dynamics of a particle pair in a viscoelastic fluid in a microchannel: effect of rheology, particle shape, and confinement. Microfluid. Nanofluidics 2019, 23, 82.
(30) Song, K.-W.; Kim, Y.-S.; Chang, G.-S. Rheology of concentrated xanthan gum solutions:Steady shear flow behavior. Fibers Polym. 2006, 7, 129-138.
(31) Wyatt, N. B.; Liberatore, M. W. Rheology and viscosity scaling of the polyelectrolyte xanthan gum. J. Appl. Polym. Sci. 2009, 114, 4076-4084.
(44) Chiarello, E.; Derzsi, L.; Pierno, M.; Mistura, G.; Piccin, E. Generation of Oil Droplets in a Non-Newtonian Liquid Using a Microfluidic T-Junction. Micromachines 2015, 6, 1825-1835.
(47) Yu, W.; Liu, X.; Zhao, Y.; Chen, Y. Droplet generation hydrodynamics in the microfluidic cross-junction with different junction angles. Chemical Engineering Science 2019, 203, 259{284.
(48) Lagus, T. P.; Edd, J. F. High-throughput co-encapsulation of self-ordered cell trains: cell pair interactions in microdroplets. RSC Advances 2013, 3, 20512.

1. A method of separating particles in a microfluidic device, the method comprising:
i) providing a microfluidic device comprising at least one microchannel, the microchannel comprising at least one first inlet and at least one first outlet;
ii) forming a mixture by suspending said particles in an aqueous viscoelastic liquid; and
iii) introducing said mixture into said microchannel via said first inlet and flowing said mixture through said microchannel at a flow rate (Q) of from 0.25 μl/min to 50 μl/min,
characterised in that said microchannel satisfies the formula L/D≥2000, wherein L represents the length of said microchannel and D represents the cross-sectional diameter of said microchannel, and said viscoelastic liquid comprises from 0.15 wt. % to 0.55 wt. % xanthan gum or from 0.05 wt. % to 1.0 wt. % hyaluronic acid.

2. The method according to claim 1, wherein said microchannel is curvilinear and, optionally, has an inner radius of curvature of from 2.5 mm to 25 mm.

3. The method according to claim 1, wherein the cross-sectional diameter (D) of said microchannel is between 50 μm and 500 μm.

4. The method according to claim 1, wherein said microchannel has a circular cross section.

5. The method according to claim 1, wherein the length (L) of said microchannel is at least 100 mm.

6. The method according to claim 1, wherein said microchannel satisfies the formula L/D≥2500.

7. The method according to claim 1, wherein said mixture comprises said particles in an amount from 0.1 wt. % to 1 wt. % and/or wherein said particles have a cross sectional diameter (d) of from 10 μm to 30 μm.

8. The method according to claim 1, wherein said microchannel provides a confinement ratio β of from 0.15 to 0.5, calculated using the formula β=d/D wherein d represents the diameter of said particles in said mixture and D represents the cross-sectional diameter of said microchannel.

9. The method according to claim 1, wherein said viscoelastic aqueous liquid comprises xanthan gum or hyaluronic acid.

10. The method according to claim 91, wherein said viscoelastic aqueous liquid comprises
from 0.2 wt. % to 0.4 wt. % xanthan gum, or
from 0.1 wt. % to 0.75 wt. % hyaluronic acid.

11. The method according to claim 1, wherein said mixture flows through said microfluidic device at a rate of from 0.3 μl/min to 15 μl/min.

12. (canceled)

13. (canceled)

14. The method according to claim 13, wherein said mixture flows through said microfluidic device at a rate of from 1 μl/min to 15 μl/min.

15. The method according to claim 1, wherein:
said microchannel has a second inlet positioned downstream of said first inlet at a distance that satisfies the formula L/D≥2000, wherein L represents the distance between inlets and D represents the cross-sectional diameter of said microchannel; and
said method further comprises, whilst introducing said mixture into said microchannel via said first inlet, simultaneously introducing a water immiscible encapsulation liquid into the microfluidic device via said second inlet at a flow rate (Q′) of from 0.25 μl/min to 50 μl/min, thereby producing droplets containing separated particles.

16. The method according to claim 15, wherein said encapsulation liquid is a mineral oil, optionally, having a viscosity of from 15 to 45 mPa·s.

17. The method according to claim 15, wherein the interfacial tension, measured using a force tensiometer, between said mixture and said encapsulation liquid is a figure between 2 mN/m and 4 mN/m.

18. The method according to claim 15, wherein said encapsulation liquid is introduced into said microchannel at a flow rate (Q′) of from 0.3 μl/min to 15 μl/min.

19. A method of co-encapsulating a plurality of distinct populations of separated particles within individual droplets, the method comprising:
a. providing a microfluidic device comprising at least a first particle separation microchannel, a second particle separation microchannel and at least a first encapsulant microchannel, wherein the first particle separation microchannel, the second particle separation microchannel and the encapsulant microchannel each comprises at least one inlet and at least one outlet, and at least one of said outlets of said first separation microchannel, at least one of said outlets of said second separation microchannel and at least one of said outlets of said encapsulant microchannel converge together to form a shared exit microchannel;
b. forming a first mixture comprising a first population of particles by suspending said first population of particles in an aqueous viscoelastic liquid, and forming a second mixture comprising a second population of particles by suspending said second population of particles in an aqueous viscoelastic liquid;
c. introducing via the inlet said first mixture into said first particle separation microchannel, and introducing via the inlet said second mixture into said second particle separation microchannel;
d. simultaneously flowing said first mixture through said first microchannel and said second mixture through said second microchannel at a flow rate (Q) of from 0.25 μl/min to 50 μl/min; and
e. whilst introducing said first mixture into said first particle separation microchannel and introducing said second mixture into said second particle separation microchannel, simultaneously introducing a water immiscible encapsulation liquid via the inlet into said encapsulant microchannel, and flowing said encapsulation liquid through said encapsulant microchannel at a flow rate (Q′) of from 0.25 μl/min to 50 μl/min,
characterised in that: said first and said second particle separation microchannels each satisfies the formula L/D≥2000, and said first particle separation microchannel, said second particle separation microchannel and said encapsulant microchannel converge at a position downstream of said first inlet of each of said first and said second particle separation microchannels at a distance that satisfies the formula L/D≥2000, wherein L represents the length of said microchannel and D represents the cross-sectional diameter of said microchannel; and said viscoelastic liquid comprises from 0.15 to 0.55 wt. % xanthan gum or from 0.05 wt. % to 1.0 wt. % hyaluronic acid.

20. A kit of parts for use in the method according to claim 1, said kit comprising:
i) said microfluidic device;
ii) an aqueous separation liquid comprising from 0.15 wt. % to 0.55 wt. % xanthan gum or from 0.05 wt. % to 1.0 wt. % hyaluronic acid; and
iii) a pressure/flow source configurable to affect the flow of said separation liquid through said microchannel at flow rate (Q) of from 0.25 μl/min to 50 μl/min.

21. A kit of parts for use in the method according to claim 15, wherein said kit comprises:
i) the microfluidic device but having a second inlet positioned downstream of said first inlet at a distance between inlets that satisfies the formula L/D≥2000, wherein L represents the length of said microchannel and D represents the cross-sectional diameter of said microchannel;
ii) an aqueous separation liquid comprising from 0.15 wt. % to 0.55 wt. % xanthan gum or from 0.05 wt. % to 1.0 wt. % hyaluronic acid;
iii) a pressure/flow source configurable to affect the flow of said separation liquid through said microchannel at flow rate (Q) of from 0.25 l/min to 50 μl/min;
iv) a water immiscible encapsulation liquid; and
v) a second pressure/flow source configurable to affect the flow of said encapsulation liquid through said microfluidic device via said second inlet at a flow rate (Q′) of from 0.25 μl/min to 50 μl/min.

22. A kit of parts for use in the method according to claim 1, said kit comprising:
a microfluidic device comprising at least a first particle separation microchannel, a second particle separation microchannel and at least a first encapsulant microchannel, wherein the first particle separation microchannel, the second particle separation microchannel and the encapsulant microchannel each comprises at least one inlet and at least one outlet, and at least one of said outlets of said first separation microchannel, at least one of said outlets of said second separation microchannel and at least one of said outlets of said encapsulant microchannel converge together to form a shared exit microchannel, and wherein said first and said second particle separation microchannels each satisfies the formula L/D≥2000, and said first particle separation microchannel, said second particle separation microchannel and said encapsulant microchannel converge at a position downstream of said first inlet at a distance that satisfies the formula L/D≥2000, wherein L represents the length of said microchannel and D represents the cross-sectional diameter of said microchannel;
one or more aqueous viscoelastic separation liquid(s) comprising from 0.15 wt. % to 0.55 wt. % xanthan gum or from 0.05 w.% to 1.0 wt. % hyaluronic acid;
a water immiscible encapsulation liquid;
at least one viscoelastic pressure/flow source(s), said source(s) configurable to affect the flow of said separation liquid through at least said first particle separation microchannel and said second particle separation microchannel at a flow rate (Q) of from 0.25 μl/min to 50 μl/min; and
a further pressure/flow source configurable to affect the flow of said encapsulation liquid through said encapsulant microchannel at a flow rate (Q′) of from 0.25 μl/min to 50 μl/min.
